(19) United States
(12) Patent Application Publication
(10) Pub. No.: US 2025/0378619 A1
(43) Pub. Date: Dec. 11, 2025

(54) GENERATIVE AI MODELS FOR IMAGE RENDERING AND INVERSE RENDERING

(71) Applicant: NVIDIA Corporation, Santa Clara, CA (US)

(72) Inventors: Zian WANG, Toronto (CA); Ruofan LIANG, Toronto (CA); Huan LING, Toronto (CA); Zan GOJCIC, Zurich (CH); Sanja FIDLER, Toronto (CA)

(21) Appl. No.: 18/737,696

(22) Filed: Jun. 7, 2024

(51) Int. Cl. G06T 15/04; G06T 15/50

(52) U.S. Cl. CPC G06T 15/04; G06T 15/50

(57) ABSTRACT

Embodiments of the present disclosure relate to rendering and inverse rendering using one or more generative models. “Rendering” refers to the process of generating a final visual image, video frame, or animation from a 2D or 3D model. “Inverse rendering” is a process that involves deducing or estimating the properties (e.g., material maps or other properties such as geometry, lighting, and textures) of a scene from observed images or visual data. Essentially, it aims to reverse the traditional rendering process. Various aspects of the present disclosure introduce editable light and material controls into generative models to allow for artistic creation. Various embodiments integrate generative models as a renderer for classic rendering pipelines to upcycle and enhance the style of rendered content.

### BACKGROUND

Generative models represent a cutting-edge advancement in artificial intelligence with respect to image processing and machine learning. Video generation models, for instance, are designed to generate realistic and coherent video frames from various inputs, such as static images or other video frames. For example, some video generation models produce highly realistic animations based on input descriptions.

However, these generative models and other image processing technologies face technical challenges in preserving identity (e.g., maintaining consistent and recognizable features of objects or characters over multiple video frames) and providing precise user control over attributes such as lighting, material properties, and scene layout. These limitations and others hinder their ability to fully replicate and utilize helpful features used in classic-graphics rendering workflows.

### SUMMARY

Embodiments of the present disclosure relate to engaging in rendering and inverse rendering using one or more generative models (e.g., a Diffusion Model (DM)). “Rendering” refers to the process of generating a final visual image or animation of a scene, which may include accounting for object geometries and other visual properties. “Inverse rendering” is a process that involves deducing or estimating the properties (e.g., material maps or other properties such as geometry, lighting, and textures) of a scene from observed images. Essentially, it aims to reverse the traditional rendering process. Various aspects of the present disclosure introduce editable light and material controls into generative models to allow for artistic creation. Various embodiments integrate generative models as a renderer to upcycle and enhance the style of graphically rendered content.

Some embodiments specifically relate to a diffusion-based renderer (e.g., DM) that uses particular inputs (e.g., material maps, noise vectors, lighting maps, and natural language text descriptions) to render one or more frames and allows for lighting control, relighting, and image enhancement. A material map of a scene defines how one or more properties vary or appear across a surface of one or more objects in that scene. Thus, a material map may define the surface properties, including color (albedo), surface detail (normal), reflectivity (metallic), roughness, and/or ambient occlusion. A lighting map represents shading and/or lighting characteristics associated with the one or more objects. It captures how light interacts with the surfaces of objects, including effects such as shadows, highlights, and/or overall illumination. In order to generate such maps, some embodiments first receive user input requesting a material property and/or lighting condition to be incorporated into an output frame.

Some embodiments then provide a first noise vector and a representation (e.g., a preprocessed version) of the material maps and/or the lighting maps as input into a machine learning model (e.g., a diffusion model) to generate an output frame, which acts as a final rendered frame. The first noise vector corresponds to an initial starting point for a diffusion process performed by the machine learning models.

Some embodiments additionally or alternatively perform still image and/or video inverse rendering using a machine learning model, such as a generative model. In an illustrative example of inverse rendering, some embodiments first receive an input frame (e.g., a particular video frame). Some embodiments then provide a first noise vector and a representation of the input frame as input into a machine learning model to generate material maps. In the context of diffusion models, for example, this noise vector serves as the initial input from which the model will iteratively refine its output to generate the material maps.

### BRIEF DESCRIPTION OF THE DRAWINGS

The present systems and methods for subcutaneous authentication are described in detail below with reference to the attached drawing figures, wherein:

FIG. 1 is a block diagram of a rendering/inverse rendering system, in accordance with some embodiments of the present disclosure;

FIG. 2 illustrates a pipeline of a rendering process where a Diffusion Model (DM) generates a rendered image based on processing specific inputs, in accordance with some embodiments of the present disclosure;

FIG. 3 illustrates a pipeline of an inverse rendering process where a DM generates one or more material maps as an output based on specific inputs, in accordance with some embodiments of the present disclosure;

FIG. 4 illustrates a pipeline of an inverse rendering process where a transformer generates an environment map as an output based on specific inputs, in accordance with some embodiments of the present disclosure;

FIG. 5 illustrates a pipeline for performing 2D frame relighting via intrinsic decomposition and neural rendering, in accordance with some embodiments of the present disclosure;

FIG. 6 illustrates a pipeline for performing 3D frame relighting via intrinsic decomposition and neural rendering, in accordance with some embodiments of the present disclosure;

FIG. 7 illustrates a pipeline for providing identify-preserving image enhancements (e.g., object insertion, compositing, or style transfer), in accordance with some embodiments of the present disclosure;

FIG. 8 is a screenshot of an example user interface for editing an input image via inverse rendering, in accordance with some embodiments of the present disclosure;

FIG. 9 is a screenshot of an example user interface for generating video frames via rendering, in accordance with some embodiments of the present disclosure;

FIG. 10 is a flow diagram of an example process for training or fine-tuning a machine learning model, in accordance with some embodiments of the present disclosure;

FIG. 11 is a flow diagram of an example process for generating an output frame or map, in accordance with some embodiments of the present disclosure;

FIG. 12A is an illustration of an example autonomous vehicle, in accordance with some embodiments of the present disclosure;

FIG. 12B is an example of camera locations and fields of view for the example autonomous vehicle of FIG. 12A, in accordance with some embodiments of the present disclosure;

FIG. 12C is a block diagram of an example system architecture for the example autonomous vehicle of FIG. 12A, in accordance with some embodiments of the present disclosure;

FIG. 12D is a system diagram for communication between cloud-based server(s) and the example autonomous vehicle of FIG. 12A, in accordance with some embodiments of the present disclosure;

FIG. 13 is a block diagram of an example computing device suitable for use in implementing some embodiments of the present disclosure; and

FIG. 14 is a block diagram of an example data center suitable for use in implementing some embodiments of the present disclosure.

### DETAILED DESCRIPTION

As described above, the limitations of generative models and image processing technologies in general hinder their ability to fully replicate classic graphics rendering workflows. For example, regarding material and surface detail, classic graphics rendering include detailed material maps (e.g., albedo, normal, roughness, metallic, ambient occlusion) to define how surfaces interact with light, providing precise control over texture and reflectivity. Consequently, artists can manually adjust every aspect of these materials to achieve the desired look. However, generative models learn from a dataset and generate new images by generalizing the patterns seen in the data. They do not currently capture the precise details and variations required for photorealism with respect to material and surface detail. It is challenging to translate detailed material properties into the latent space of a generative model, limiting the ability to fine-tune textures and surface details and allow any editing.

In another example, with respect to scene layout and spatial consistency, classic rendering workflows allow artists to have full control over the placement and properties of objects in a scene, ensuring spatial consistency and accurate interactions between objects. Classic workflows allow for precise positioning and animation of objects, crucial for maintaining the intended composition and dynamics of a scene. However, with respect to Generative models, they often produce artifacts and inconsistencies, especially in complex scenes with multiple objects and interactions. For example, there may be rapid and noticeable changes in brightness or color between consecutive frames, leading to a flickering effect. There may also be temporal jitter, which is sudden, unnatural jumps or shifts in the motion of objects within the video. These and other anomalies lead to poor frame quality and inaccuracy in video frame prediction. Moreover, undesired artifacts and anomalies are not just limited to video generation, but they can arise in any digital media format, such as digital photographs. With respect to digital photographs, artifacts can include elastic deformities, misplaced pixels, or pixel saturation. Further, many generative models operate in 2D space and struggle to maintain consistent object relationships and perspectives across different parts of an image or between frames in a video.

In another example, with respect to temporal coherence in animation, classic graphics rendering techniques ensure that each frame is consistent with the previous ones, maintaining temporal coherence. Techniques like key-frame animation, motion capture, and procedural animation allow for detailed and precise control over movements and interactions. However, generative models struggle to maintain temporal coherence in video generation, leading to flickering or inconsistent object appearances between frames. Generative models often struggle with dynamic scenes where objects move or change properties over time, as the temporal dependencies are complex to model accurately.

With respect to user control and customization, classic rendering technologies include interactive tools that provide artists with complete control over every aspect of the scene, from lighting and materials to camera angles and object placement. This allows for high customization and precise adjustments. Generative models, however, can be seen as black boxes, where fine-tuning specific attributes requires adjusting high-dimensional latent spaces, which is not intuitive. Current generative AI tools often lack the interactive and granular control that artists are accustomed to in traditional rendering software.

Lastly, with respect to realistic light simulation, some classic rendering technologies simulate the complex interactions of light with materials in a physically accurate manner (e.g., via ray and path tracing), to produce photorealistic images. More advanced classical rendering techniques can account for multiple light bounces, reflections, refractions, and shadows. However, these techniques are computationally expensive and time-consuming, often requiring powerful hardware and long rendering times, especially for high-resolution images and animations. With respect to generative models, they can, for example, be a Generative Adversarial Network (GAN) that approximates the process of light interaction based on training data. While they can produce visually appealing images, they often lack the fine details and precise control over light transport relative to classic rendering technologies. Generative models can also struggle to scale up to the same level of physical accuracy provided by path tracing and ray tracing without significant computational resources and sophisticated training techniques.

Various aspects of the present disclosure bridge this gap between generative models and classic computer graphics by (1) introducing editable light and material controls into generative models to allow for finer, more precise control of artistic creation, and (2) integrating generative models as a renderer for classic software rendering pipelines to upcycle and enhance the style of rendered content. Some embodiments specifically relate to a diffusion-based renderer that uses particular inputs (e.g., material maps and natural language text descriptions) to render one or more frames and allows for lighting control, relighting, and image enhancement.

In operation, some embodiments perform still image and/or video rendering (e.g., rendering a digital twin of an ego machine traversing an environment) using a machine learning model, such as a generative model. As used herein, “rendering” refers to the process of generating a final visual image, video, or animation from a 2D or 3D model using computer software. This process involves several steps and computations to transform the model, which includes shapes, textures, lighting, and camera angles, into a fully realized image. Some embodiments first receive one or more material maps (e.g., albedo, normal, roughness) and/or one or more lighting maps. A material map defines how one or more properties vary or appear across a surface of one or more objects. Thus, a material map defines the surface properties, including color (albedo), surface detail (normal), reflectivity (metallic), roughness, and ambient occlusion.

A lighting map represents shading and/or lighting characteristics associated with the one or more objects. A lighting map (or light map) is thus a data structure used in computer graphics to store precomputed lighting information for a 3D scene. It captures how light interacts with the surfaces of objects, including effects such as shadows, highlights, and/or overall illumination. By using lighting maps, rendering engines can achieve realistic lighting effects without the need for complex real-time calculations, which improves performance, especially in static or semi-static scenes.

In order to generate such maps, some embodiments first receive user input requesting, specifying, or otherwise indicating a material property and/or lighting condition to be incorporated into an output frame. Based at least in part on the user input, some embodiments generate the material maps and/or the lighting maps. For example, a user may first input a noisy image and specify, in natural language, “wooden floor with glossy finish.” Responsively, various embodiments generate multiple material maps that serve a specific purpose in defining the surface properties of the wooden floor. For a wooden floor, for example, the albedo map would include the base appearance (e.g., texture and color) of the wood without any lighting or shading applied, showing the grain patterns and the natural color variations of the wood planks. The normal map would depict the fine details of the wood grain, the small imperfections, and the subtle bumps on the wooden surface. It enhances the perception of depth and texture on the wooden floor. For a glossy wooden floor, the roughness map would have low roughness values, indicating a smooth and reflective finish. The map might still have slight variations to reflect minor surface imperfections or differences in the wood grain. Since wood is a non-metallic material, the metallic map would be entirely black, indicating that the wooden floor does not have any metallic properties.

In another example of a user providing lighting information, a user may indicate, in natural language, “Bright afternoon sunlight streaming through a large window from the left side of the room.” Various embodiments may first parse the user input (e.g., via natural language processing, such as Named Entity Recognition) to identify key elements, such as Time of Day: Afternoon (implies warm, strong light), Light Source: Sunlight, Direction: From the left side, Intensity: Bright, Modifiers: Streaming through a window (implies some soft shadowing). Some embodiments then create the lighting environment through various algorithms. For example, in Spherical Harmonics (SH), embodiments use SH coefficients to approximate the environment lighting. Some embodiments use environment maps to create or select an environment map that matches the description of a bright afternoon with sunlight. Some embodiments use light source properties to define the properties of the main light source (sunlight). Responsively, various embodiments then generate the lighting map as follows. The directional light source simulates sunlight, which involves setting the direction, intensity, and color temperature (warm afternoon light). There may also be soft shadows. Since the light is streaming through a window, some embodiments add soft shadows to the lighting map to reflect the diffusion of light through the windowpanes. Some embodiments add ambient lighting to simulate the overall brightness of the room, ensuring that areas not directly lit by the sunlight still receive some illumination.

Some embodiments then provide a noise vector and a representation (e.g., a vector) of the material maps and/or the lighting maps as input into a machine learning model (e.g., a diffusion model) to generate an output frame, which acts as a final rendered frame. The noise vector corresponds to an initial starting point for a diffusion process performed by the machine learning models. In some embodiments, the machine learning model is a diffusion model. Diffusion models are a class of probabilistic models that leverage mapping an easy-to-sample distribution (e.g., pixel white noise) to a hard-to-sample target distribution, such as a clean image or video frame with no noise or artifacts. The noise distribution for frame prediction may be a standard-normal distribution for each pixel and RGBA channel in the predicted frame. A diffusion model is trained to incrementally convert samples from the noise distribution (represented by the noise vector) to samples (e.g., frames) from the training distribution. In an illustrative example, a diffusion model could be trained to convert standard-normal pixel noise into multiple video frames from a video frame sequence.

Diffusion models typically perform a diffusion process by incrementally converting from the noise distribution or noise vector to the target distribution or frame in a number of steps, where the state of all previous steps is encoded in a representation of the same dimension as the noise and image. Diffusion models may use one or more steps (e.g., 5 or more steps) in such diffusion process. Each step of the diffusion process converts a “noisy” representation of an image (initially, the input is nothing but noise) into a slightly “less noisy” representation in a progressive manner, so that by the last step of the process we have a sample of a pure image.

Diffusion models may be conditioned in practice by “prompts” that alter the target distribution of the noise-to-image process. Diffusion models generate frames (e.g., images) by iteratively denoising a noisy input frame, gradually refining it to produce a clean frame. The conditioning mechanism alters this denoising process to steer the model toward generating frames that meet specific criteria provided by the prompts. In some embodiments, such specific criteria or conditioning information include material maps, lighting maps, and/or user input. Cross-attention layers are integrated into the model to incorporate the conditioning information (e.g., material maps, lighting maps, user prompts) at multiple stages of the denoising process. By using cross-attention mechanisms, a diffusion model can effectively integrate and condition on material maps, lighting maps, and user inputs, as described in more detail below. This allows the model to generate high-quality frames that meet specific user-defined criteria, blending the strengths of neural networks with traditional computer graphics attributes for precise and realistic rendering.

The noise vector is combined with the representations of the material and lighting maps. This combination can be done through concatenation or other mathematical operations that integrate the noise with the scene properties. In some embodiments, the combined input (two or more of noise vector, material maps, and lighting maps, etc.) is fed into a diffusion model. This generative model then iteratively refines the noisy input to generate the final output frame. To do this, in some embodiments, the diffusion model starts with the initial noise vector. This noisy input is progressively refined through several iterations. In one or more (e.g., each) iterations, the diffusion model does the following: it receives the current noisy representation, which includes the integrated information from the material and lighting maps. The diffusion model then applies a denoising step using a neural network trained to reduce noise and enhance the details based on the material and lighting properties. It then generates an intermediate output that is less noisy and more accurate than the previous iteration. This iterative process continues for a set number of steps, each iteration improving the quality and accuracy of the output. After the final iteration, the diffusion model produces a high-quality output frame that acts as the final rendered frame. This frame integrates the material properties and lighting conditions, creating a realistic and detailed image.

In some embodiments, the diffusion model is trained on a dataset of rendered frames and corresponding material and lighting maps. During training, the model learns to predict the final rendered frame by progressively refining noisy inputs using the scene properties. During actual usage (inference), the model receives a noise vector and the representations of material and lighting maps, processes them through iterative denoising steps, and outputs the final rendered frame.

In some embodiments, these final rendered frames (and/or other objects, such as material maps) are editable. Thus, particular embodiments edit or otherwise modify one or more features based on executing a user request. User editing is easier and closer to classic computer graphics workflows primarily due to the use of material maps and/or the structured, modular approach to rendering. By using these material maps, users can independently adjust different properties of the scene without affecting other aspects. Each material map represents a specific aspect of the surface's appearance, making it easier for users to understand and edit the properties they want to change. For instance, if a user wants to make a surface less reflective, they can directly edit the specular map without altering the color or texture. Further, the iterative process of a diffusion model allows users to see progressive improvements and changes in real-time or near real-time. This feedback loop is helpful for making fine adjustments and achieving the desired visual outcome efficiently.

Some embodiments additionally or alternatively perform still image and/or video inverse rendering using a machine learning model, such as a generative model. As used herein, “inverse rendering” is a process that involves deducing or estimating the properties (e.g., material maps or other properties such as geometry, lighting, and textures) of a scene from observed images or visual data. Essentially, it aims to reverse the traditional rendering process. While traditional rendering generates images from 3D models and scene descriptions, inverse rendering works to deconstruct an image of a scene into representations of the scene's properties.

In an illustrative example of inverse rendering, some embodiments first receive an input frame (e.g., a particular video frame). Some embodiments then provide a first noise vector and a representation of the input frame as input into a machine learning model to generate material maps. In the context of diffusion models, for example, this noise vector serves as the initial input from which the model will iteratively refine its output to generate the material maps. In an illustrative example, the input frame is first passed through a feature extractor, such as a convolutional neural network (CNN). The feature extractor identifies important features from the image, such as edges, textures, and color distributions.

The first noise vector is combined with the representation (e.g., features) extracted from the input frame. This combination can be done through concatenation or by other methods such as adding or multiplying the noise vector with the image features. The combined input (noise vector+image representation) is fed into a diffusion model. During each step, the model uses the combined input to gradually reduce the noise and refine its estimates of the material maps.

The diffusion model starts with the initial noise vector. This vector is a random, noisy representation that will be refined over several iterations. In one or more (e.g., each) iterations, the diffusion model: receives the current noisy representation, and applies a denoising step using the features extracted from the input frame, which involves using a neural network trained to reduce noise and move the representation closer to the true material maps. The diffusion model generates an intermediate output that is slightly less noisy and more accurate than the previous iteration. This process is repeated for a predefined number of iterations, with each step bringing the output closer to the final, high-quality material maps. After the final iteration, the output of the diffusion model is a set of material maps that describe the surface properties of the scene.

In some embodiments, initially, the diffusion model is trained on a large dataset where each input frame is paired with corresponding material maps. The model learns to predict the material maps by iteratively refining noisy inputs to match the training data. During actual usage (inference), the model receives an input frame and a noise vector, processes them through iterative denoising steps, and outputs the material maps. These maps can then be used for various applications, such as rendering the scene with different lighting conditions, integrating virtual objects, or creating augmented reality experiences.

There are various technical effects and improvements by utilizing various embodiments of the present disclosure. For example, there is improved accuracy and fidelity with respect to the output (e.g., a rendered frame). This is because, unlike existing generative models, various embodiments incorporate the technical solutions of material maps, lighting maps, and/or noise vectors. Each of these solutions ensures that the fidelity and quality will be high, ensuring, for example, that a requested “glossy” surface of a material is indeed glossy.

Another technical effect is improved human-computer interaction. Existing generative models do not allow for material map or other robust controls or editing. As such, various embodiments allow non-professional users to specify lighting and material properties through simple text commands or user interface selections. For example, a user can type “make the floor wooden with a glossy finish,” and the model will adjust the material maps accordingly. Users can intuitively modify images and videos by describing the desired changes in natural language, without needing in-depth technical knowledge of 3D graphics or material science. This level of control allows for precise modifications, resulting in highly accurate and customized visual outputs.

Another technical effect is reduced computing resource consumption, such as reduced latency and I/O. For example, some embodiments condition (e.g., via cross attention) the models on specific parameters (e.g., material maps, lighting, user input). By conditioning the diffusion models on specific graphic parameters such as materials and environment lighting, the invention ensures that only relevant data is processed. This reduces the amount of data that needs to be loaded and processed, thereby conserving memory and reducing I/O operations. For instance, focusing on key material properties and essential lighting conditions avoids the need to process extraneous data, leading to more efficient resource usage. In another example, the model in some embodiments leverages parallel processing capabilities to perform multiple computations simultaneously. This can include parallelizing the denoising steps and processing multiple parts of the image or inputs (e.g., material maps, lighting maps, and/or user input) concurrently. Parallel processing significantly reduces latency by distributing the computational load across multiple processors or cores.

The systems and methods described herein may be used by, without limitation, ego machines such as non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications. For example, one or more output frames described herein can represent simulation of a digital twin ego machine as an ego machine traverses an environment.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs), systems for performing light transport simulation, systems for performing collaborative content creation for 3D assets, systems implemented at least partially using cloud computing resources, and/or other types of systems.

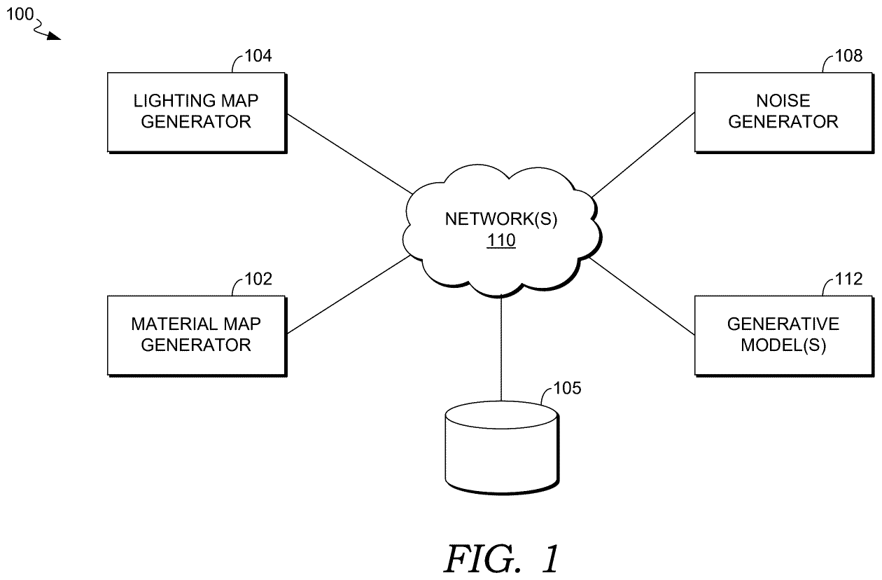

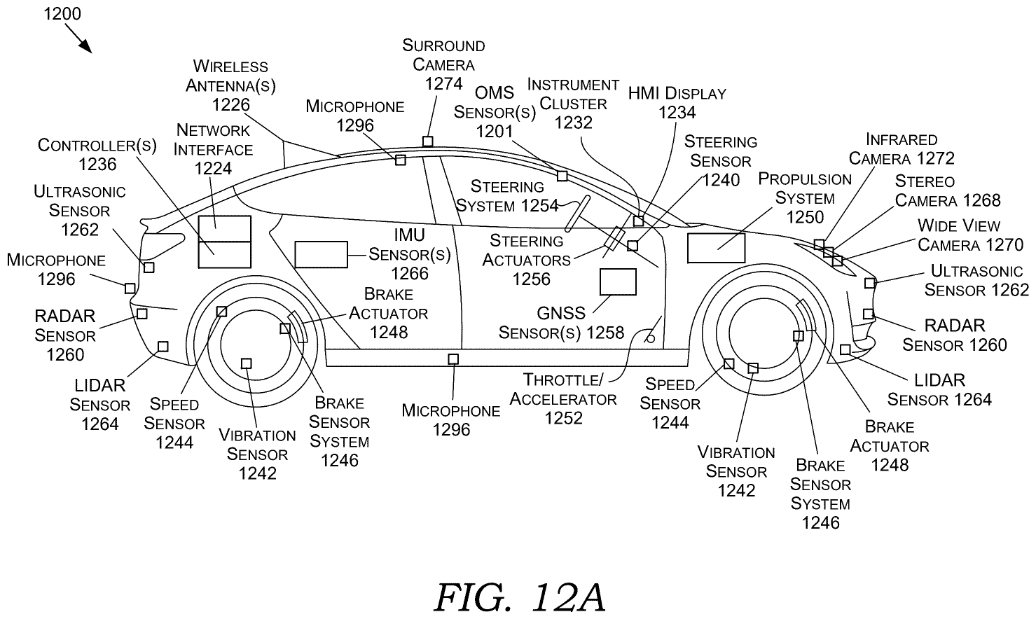

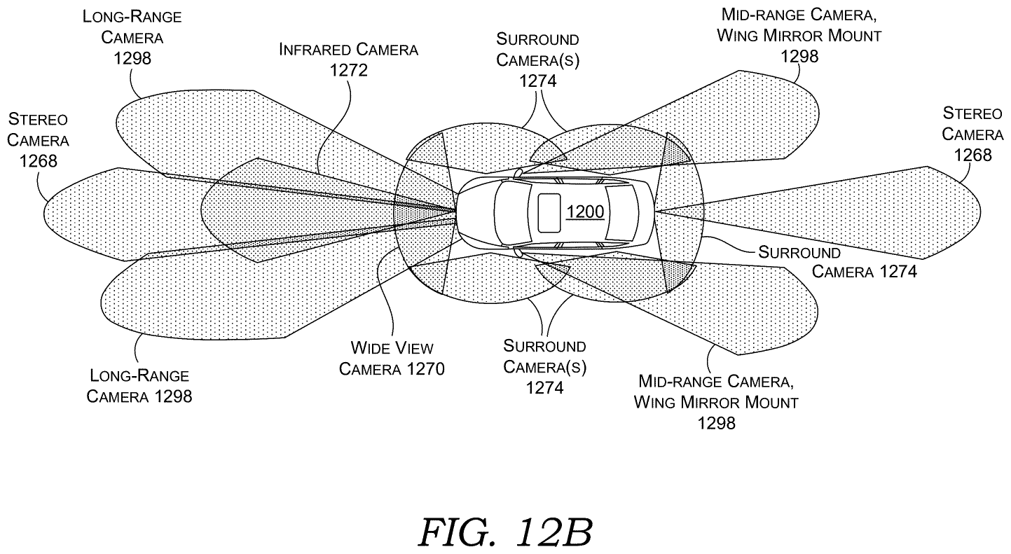

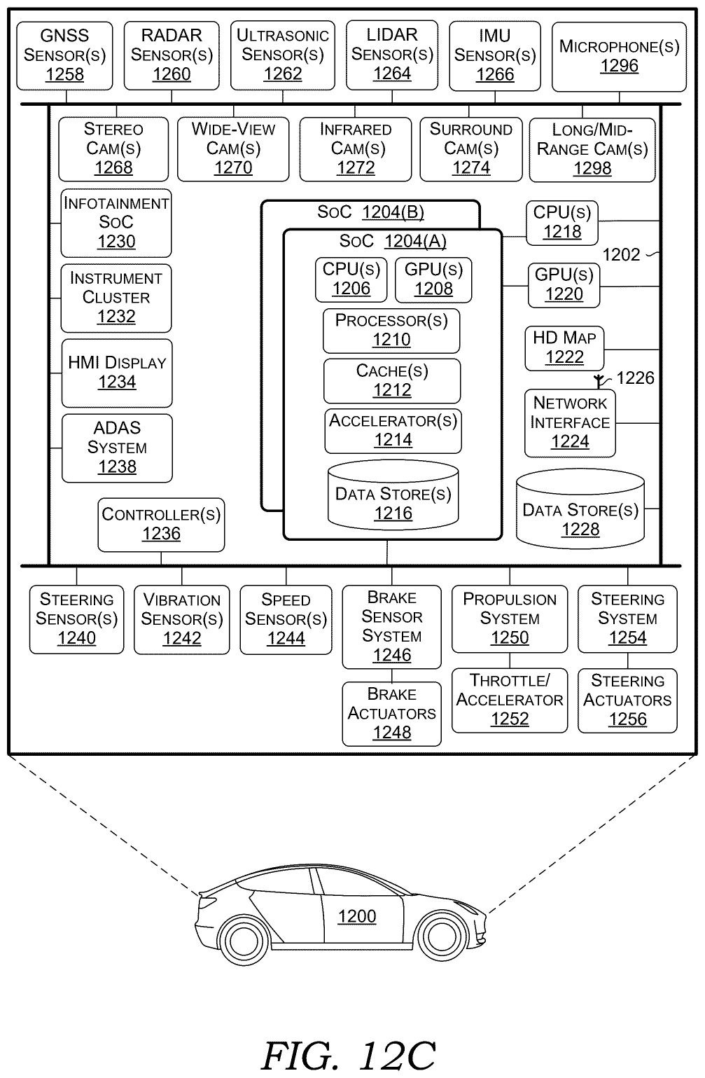

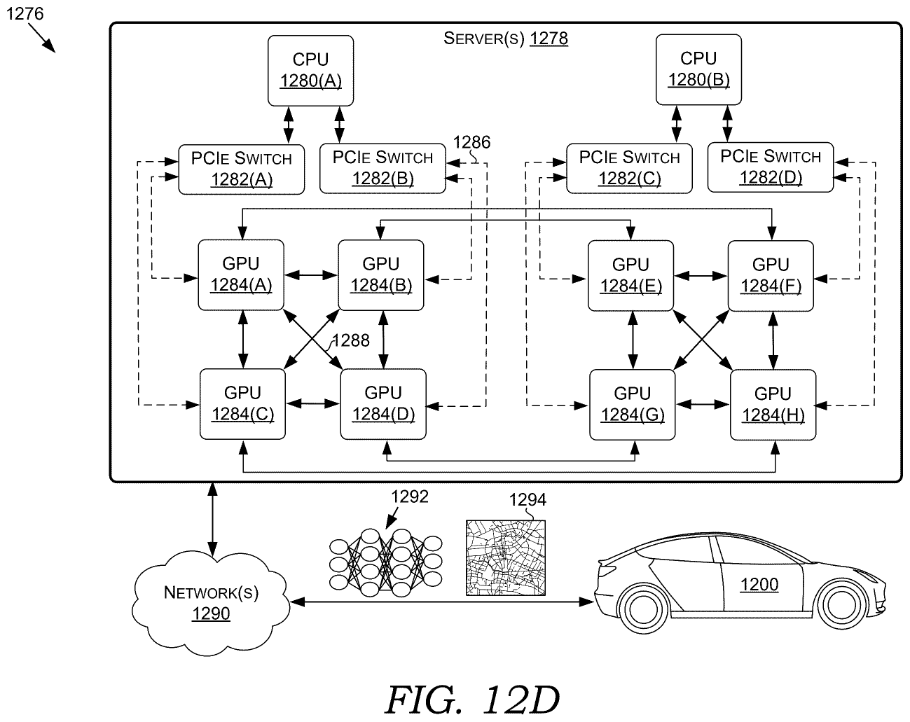

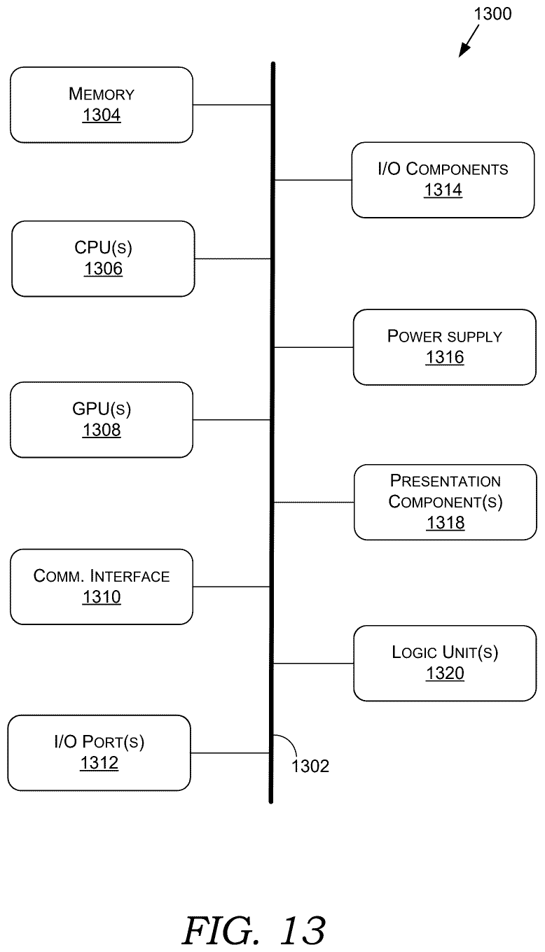

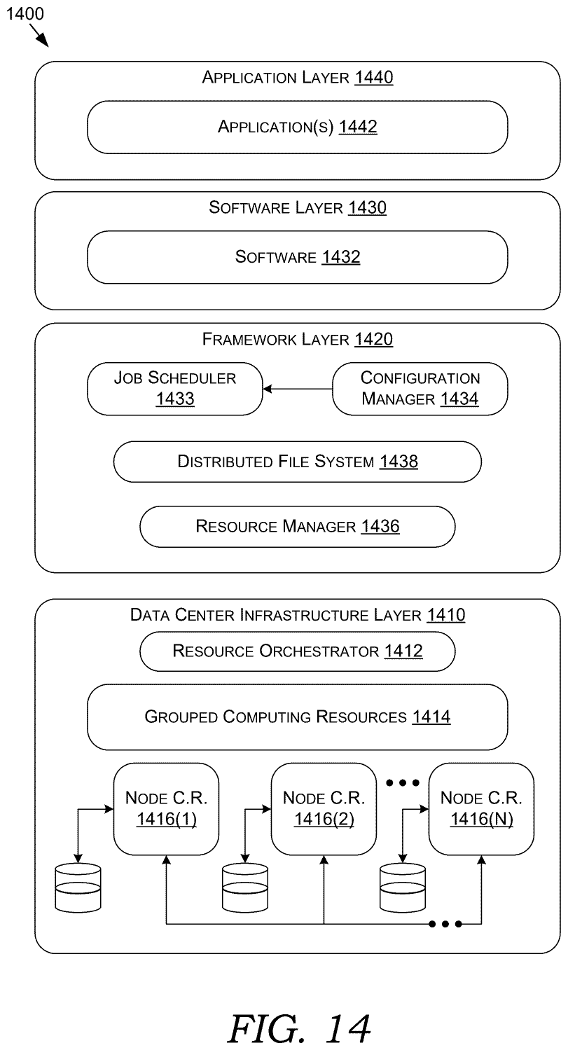

With reference to FIG. 1, FIG. 1 is a block diagram of a rendering/inverse rendering system 100 (referred to as “system 100”), in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionalities to those of example autonomous vehicle 1200 of FIGS. 12A-12D, example computing device 1300 of FIG. 13, and/or example data center 1400 of FIG. 14. In the embodiment illustrated in FIG. 1, the system 100 includes a material map generator 102, a lighting map generator 104, a noise generator 108, a generative model(s) 112, and storage 105, each of which is communicatively coupled via the network(s) 110 (e.g., a Wide Area Network (WAN), a Local Area Network (LAN), an interconnect, an internal bus structure where all components are hosted on same device, or the like). In some embodiments, the material map generator 102, lighting map generator 104, and/or the noise generator 108 is included within the generative model(s) 112, as opposed to being separate components as illustrated in FIG. 1.

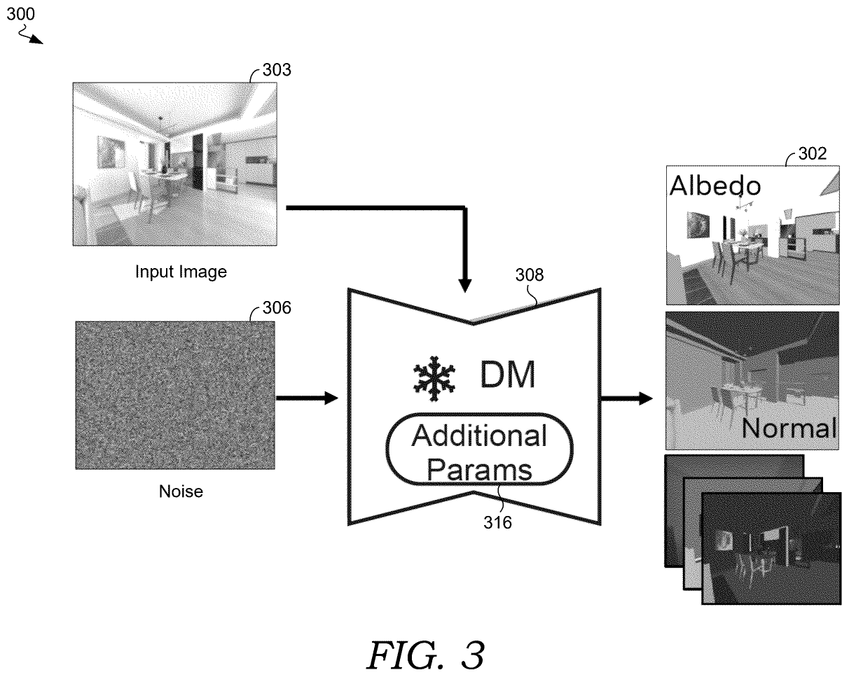

In one or more implementations, the material map generator 102 is generally responsible for generating one or more material maps. In some embodiments, a material map is generated based on the generative model(s) 112 generating the material map. For example, the generative model(s) 112 takes, as input, an input image, a noise vector (as generated by the noise generator 108), and/or one or more lighting maps (generated by the light map generator 104) to generate one or more material maps, which is described in more detail below (see e.g., FIG. 3).

In some embodiments, a material map is alternatively or additionally generated from a baseline input image. Creating material maps from an input image involves a series of computational steps to extract surface properties such as color, texture, reflectivity, and surface normals. For example, with respect to an albedo map, various embodiments extract the base color of the surface of an input image without lighting effects such as shadows and highlights. Some embodiments first remove lighting effects from the input image to isolate the intrinsic color of the material. Some embodiments then separate the image into its intrinsic components: illumination and reflectance (albedo). Such albedo map extraction in some embodiments is realized through the following equation:

$$I ( x , y ) = R ( x , y ) \cdot L ( x , y )$$

where I(x,y) is the input image, R(x,y) is the reflectance (albedo) map, and L(x,y) is the illumination map. Some embodiments solve for (x,) by estimating (x,y) through techniques like Retinex theory or optimization algorithms that minimize variations in R under varying L.

Regarding a normal map, some embodiments derive or extract the surface normals from the input image to represent the fine details and textures. This is done in some embodiments using photometric stereo, where, for example, multiple images are taken under different lighting conditions to estimate the surface normals. Some embodiments estimate the surface normals from variations in shading in a single image using the following equation: I=N·S, where I is the intensity vector of images under different light sources, N is the normal vector, and S is the light source direction vector. Some embodiments additionally or alternatively perform shape-from-shading algorithms, such as represented by:

$$I ( x , y ) = ρ ( x , y ) \cdot ( N ( x , y ) \cdot L )$$

where I(x,y) is the intensity at pixel (x,y), p(x,y) is the albedo at pixel (x,y), N(x,y) is the normal at pixel (x,y), and L is the light direction. Particular embodiments solve for N using optimization methods that minimize the difference between the observed and predicted intensities.

Some embodiments estimate a roughness map of the input image by estimating the surface roughness, indicating how smooth or rough the surface is. This estimation may include analyzing the size and spread of specular highlights to estimate roughness. Particular embodiments analyzing the frequency content of the image to distinguish between smooth and rough areas, via the following equation:

$$Roughness = {σ21}_{i , j} \sum ( {I}_{specular} ( i , j ) - {μ}_{specular} ) 2$$

where Ispecular(i,j) is the intensity of the specular reflection at pixel (i,j), μspecular is the mean intensity of the specular reflection, and σ2 is the variance of the specular reflection intensity. Various embodiments thus compute the variance of the specular highlight intensity to estimate roughness.

Regarding a metallic map, particular embodiments determine whether each pixel represents a metallic or dielectric material. Metallic surfaces typically have distinct reflectance properties and lack diffuse color. Some embodiments compute the ratio of specular to diffuse reflectance to classify metallic vs. non-metallic. Various embodiments thus compute the variance of the specular highlight intensity to estimate roughness.

Regarding ambient occlusion maps, some embodiments estimate the occlusion of ambient light, indicating how much light is blocked by surrounding geometry. To do this, some embodiments analyze the 3D geometry to determine areas that are occluded from ambient light. Some embodiments use depth information to estimate occlusion, such as via this equation:

$$AO ( x , y ) = 1 - π1 \int hemisphere V ( ω , x , y ) ( N ( x , y ) \cdot ω ) d ω$$

where V(ω,x,y) is the visibility function at direction w and pixel (x,y), and where N(x,y) is the normal at pixel (x,y). Various embodiments thus Integrate the visibility function over the hemisphere to compute ambient occlusion.

In some embodiments, a material map is additionally or alternatively generated based on receiving user input. Generating a material map based on user input that describes surface properties involves translating qualitative descriptions or user interface selections into quantitative parameters that define the appearance of the surface. This process leverages pre-trained models or predefined rules to convert user descriptions into specific material map values.

In an illustrative example, a user input may be to generate, at an output frame, a “wooden floor with glossy finish.” Various embodiments, then identify keywords that describe the material type and surface properties, such as via Named Entity Recognition (NER) or other NLP-based techniques. For example, various embodiments generate the following tags (represented by < >), “wooden”<material type>, “glossy”<surface finish>. Various embodiments then map the description-tag pair (e.g., “wooden”<material type>) to tags or other identifiers that identity material maps or properties. For instance, some embodiments assign basic color and texture properties based on the material type. Using the illustration above, “wooden” maps to a specific color and wood grain texture. Various embodiments then map such material maps to their corresponding equation (as illustrated above) to derive the material maps. For example, a lookup data structure or other hash map may be used where the key is represented by material map identifiers or tags (e.g., “Albedo”) and the values in the look-up structure represent the equation needed to actually access and then generate the corresponding material map.

The lighting map generator 104 is generally responsible for generating one or more maps that describe lighting and/or shading/shadows. As with the material map generator 102, in some embodiments, the lighting map generator 104 is generated based on extracting information (e.g., pixel wise information) from an input image. For example, to generate a lighting map from an input image, some embodiments use spherical harmonics, environment maps, and/or latent variables by decomposing the lighting information from the input image and representing it in a way that the model (e.g., a diffusion model) can utilize effectively.

For example, some embodiments extract lighting information from the input image via spherical harmonics (SH). SH are a set of orthogonal basis functions defined on the surface of a sphere. SH are particularly useful in computer graphics for efficiently representing and manipulating functions defined over spherical domains, such as lighting environments. They provide a compact representation of the light distribution over a sphere, which is particularly useful for ambient lighting. Various embodiments thus project the Environment onto SH—they project the environment lighting captured in the input image onto the spherical harmonics basis functions.

Some embodiments first project the environment lighting captured in the input image onto the spherical harmonics basis functions:

$$L ( θ , ϕ ) \approx l = 0 \sum Lm = - l \sum lclmYlm ( θ , ϕ )$$

where L(θ,ϕ) is the lighting function at spherical coordinates (θ,ϕ), Ylm(θ,ϕ) are the spherical harmonics basis functions, and clm are the SH coefficients.

Environment maps capture the entire lighting environment surrounding the scene. They may be represented as high dynamic range (HDR) images that provide detailed information about the light sources and their intensities. Some embodiments convert the input image to an environment map by using image-based lighting techniques to convert the input image into an environment map, such as cube map generation. For example, such conversion can occur via the following equation:

$$E ( x , y ) = HDR ( x , y )$$

where E(x,y) is the environment map value at pixel (x,y), and HDR(x,y) is the high dynamic range value at pixel (x,y).

Latent variables are abstract representations learned by neural networks that capture complex features of the lighting environment. In these embodiments, some embodiments extract latent features by using a neural network (e.g., a variational autoencoder) to encode the lighting information into latent variables such as via: z=fencoder(I), where z is the latent vector, fencoder is the encoding function of the neural network, and I is the input image.

Some embodiments then concatenate or combine the SH coefficients, environment map, and latent variables to create a comprehensive lighting map, such as via the following equation:

$$Lfinal ( x , y ) = α L S H ( θ , ϕ ) + β L e n v ( x , y ) + γ Llatent$$

where Lfinal(x,y) is the final lighting map value at pixel (x,y), α, β, γ are weights that balance the contributions from SH, environment map, and latent variables. In other words, various embodiments compute lighting maps by using spherical harmonics to capture ambient lighting, convert the input image to an environment map for detailed lighting, and/or encode lighting features into latent variables using a neural network. Various embodiments then concatenate or combine these features by computing the lighting contributions from SH, environment map, and latent variables. Some embodiments combine these components to create the final lighting map using weighted sums. By following these operations and using the respective equations, a lighting map can be generated from an input image that incorporates ambient lighting, detailed environment lighting, and abstract features captured by latent variables.

As described above with respect to the material map generator 102, in some embodiments, the lighting map generator 104 additionally or alternatively generates lighting maps based on receiving and processing user input based on user input that describes specific lighting conditions involves translating natural language descriptions into actionable parameters that can be used to create the lighting map. This process can leverage Natural Language Processing (NLP) techniques, such as Named Entity Recognition (NER), to extract key elements from the user input and map them to corresponding lighting concepts. For example, a user may specify lighting conditions, such as “bright afternoon sunlight streaming through a large window from the left side of the room.” NER may then responsively extract entities in this user input such as “time of day” (afternoon), “light source” (sunlight), “intensity” (bright), “direction” (left side), and “modifiers” (streaming through a window). An Example NER Output is: Time of Day: “afternoon,” Light Source: “sunlight,” Intensity: “bright,” Direction: “left side,” and Modifiers: “streaming through a window.”

Some embodiments then map such extracted information to lighting parameters by translated extracted entities into parameters used to create the lighting map. For example, in a lookup structure, the keys may represent the parameters and the values may represent the extracted entities. For instance, lighting parameters may first be defined, such as Time of Day: “afternoon” implies warm, strong light, Color temperature around 5000K to 6000K (Kelvin). Light Source: “sunlight” implies directional light. Intensity: “bright” implies high intensity. Direction: “left side” implies the light direction vector. Modifiers: “streaming through a window” implies soft shadows.

Some embodiments then compute a directional light source (e.g., based on user input that states where the light source is), such as via the equation: L=I·D L=I·D, where L is the lighting vector, I is the light intensity, and D is the direction vector, some embodiments additionally map time of day to color temperature, create an environment map reflecting the user-specified lighting conditions, and apply soft shadows to simulate window effects. By leveraging NLP and mathematical models, user descriptions can be effectively translated into detailed lighting maps suitable for realistic rendering in 3D scenes. This approach allows for intuitive and flexible lighting control based on natural language input.

The noise generator 108 is generally responsible for generating one or more noise vectors to generate a frame or other intermediate object, such as a material map. A noise vector is a random vector drawn from a specific distribution, such as a Gaussian distribution. It represents a highly noisy version of the final frame or other object (e.g., a material map or lighting map). In diffusion models, this noise vector is gradually transformed into a clean frame or object through a series of denoising steps. In the context of diffusion models, alpha (α) represents the noise level in the image. The initial alpha value (α0) is typically set close to 1, indicating a high level of noise, such as pure noise.

Some embodiments first sample from a Gaussian distribution and then apply an initial noise level. For example, regarding sampling, a noise vector z is sampled from a Gaussian distribution (0), where I is the identity matrix—z˜N(0,I). With respect to applying the initial noise level, the noise vector at the initial alpha value may be the sampled Gaussian noise, as α0≈1.

In one or more implementations, the noise vector is progressively denoised through multiple iterations, guided by the generative model(s) 112's learned parameters. In some embodiments, a forward diffusion process (adding noise) is first performed by starting from a clean frame (e.g., an input image) x0x0, noise is added over time steps t. At each time step t, the image xt is represented as:

$$xt = √ atx 0 + √ 1 - {a}_{t} z$$

where αt is the noise level at time step t and z˜N(0,I) is the Gaussian noise. In some embodiments, the noise generator 108 then performs a reverse diffusion process (denoising), where the generative model(s) 112 (e.g., a diffusion model) model learns to reverse the noise addition process, starting from xT (a highly noisy version) and progressively denoising it to generate a final output frame. At each reverse step t, the denoising process involves predicting the original image x0 from xt:

$$xt - 1 = xt - ϵ θ ( xt , t )$$

where ϵθ(xt,t) is the model 112's prediction of the noise component at step t. As the iterations proceed, at decreases, reducing the noise in the image: αt=αₜ₋₁−Δα. The model 112 refines the image step-by-step, progressively removing noise based on the learned noise patterns.

In one or more implementations, the generative model(s) 112 takes, as input, one or more of: an input image, a noise vector (as generated by the noise generator 108), one or more material maps (generated by the material map generator 102), and/or one or more lighting maps (generated by the light map generator 104). The generative model(s) 112 uses the input information to generate an output frame and/or other objects, such as a material map (as generated by the material map generator 102), which is described in more detail below.

The system 100 further includes storage 105. Storage 105 represents any suitable data store (e.g., a database or other data structure) or storage device(s) (e.g., a Storage Area Network (SAN), RAM, RAID, disk) that stores any suitable data, such as frames, models, routines, models, or the like. For example, storage 105 can include input frames that are uploaded by a user and output frames that are generated by the generative model(s) 112, and any other objects, such as material maps generated by the material map generator 102, lighting maps generated by the lighting map generator 104, and noise vectors generated by the noise generator 108.

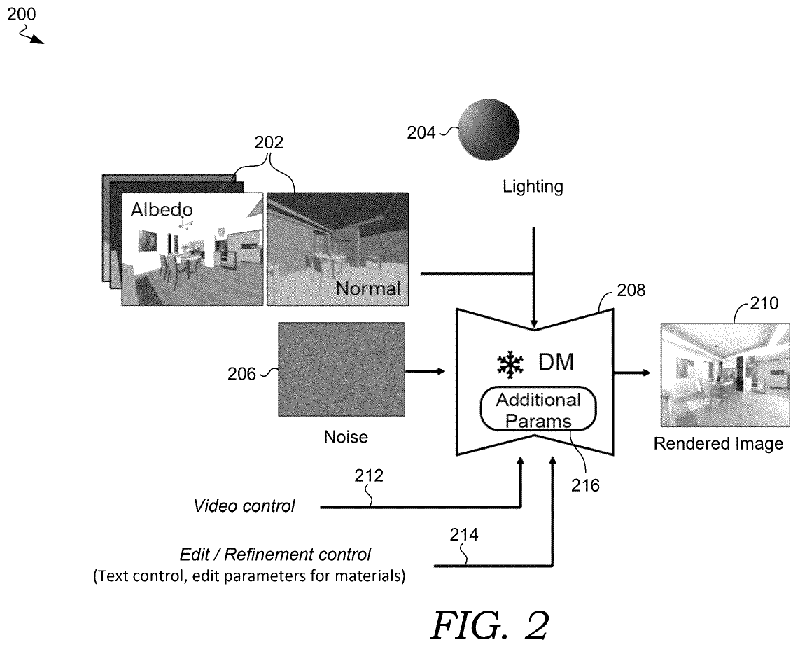

FIG. 2 is a pipeline 200 illustrating a rendering process where a Diffusion Model (DM) generates a rendered image 210 (an output frame) based on processing specific inputs, according to some embodiments. In some embodiments, the material maps 202 represent the material maps generated by the material map generator 102 of FIG. 1, the lighting 202 represents the lighting maps generated by the lighting map generator 104, the noise vector 206 represents the noise vector generated by the noise generator 108 of FIG. 1, and the DM 208 represents the generative model(s) 112 of FIG. 1.

FIG. 2 illustrates a workflow for neural rendering, illustrating how a diffusion model (DM) 208 is used to enhance or replace classic physically-based rendering techniques like path tracing. The DM 208 takes, as input, the material maps 202, the noise vector 206, and the lighting 204 to generate a final rendered image 210, which reflects the specified lighting and material properties. The DM 208 uses the provided information/inputs (i.e., 202, 204, 206, 212 and 214) to condition the denoising process, progressively refining the noisy input into a high-quality rendered image 210.

In some embodiments, the DM 208 represents a U-NET machine learning model. A U-Net (“U-shaped network”) is a type of convolutional neural network (CNN) architecture that may be used for image segmentation tasks. However, it can also be adapted for various other tasks, including generating frames or images. The U-Net architecture is characterized by a U-shaped structure, where the contracting path captures context and the expansive path enables precise localization.

In some embodiments, the U-Net takes input data that provides the context for frame generation. This input may include one or more frames, or additional information describing the desired content or conditions (i.e., the noise vector 206, the material maps 202, and the lighting 204). The input data may then pass through a series of convolutional layers, each followed by an activation function (e.g., ReLU) and/or normalization layers (e.g., batch normalization). Downsampling operations such as max-pooling or strided convolutions may then occur, which reduce the spatial resolution while capturing hierarchical features. Then a bottleneck function may occur—the contracting path leads to a bottleneck layer where the most abstract and compressed representation of the input data is obtained. Then an expansion path function or decoder functionality is performed. The expansive path involves upsampling operations (e.g., transposed convolutions) to gradually restore the spatial resolution. Skip connections may then concatenate feature maps from the contracting path at corresponding levels, aiding in the recovery of fine details and preventing information loss. The final layer of the U-Net generates the output frames deterministically based on the processed information. For deterministic frame generation, a linear activation function might be used if predicting pixel values directly. Alternatively, other activation functions appropriate for the specific task could be employed. During training, a deterministic loss function may be employed to measure the discrepancy between the predicted frames and the ground truth frames. For example, loss functions for deterministic frame generation include mean squared error (MSE) or other regression-based loss functions, depending on the nature of the output.

Cross-attention mechanisms within the DM 208 enable the DM 208 to integrate conditioning information (albedo, normal maps, lighting) effectively during the denoising process. This involves aligning and focusing on relevant parts of the conditioning inputs while refining the noisy image. Various embodiments first generate an input embedding, which includes the noise vector 206 and conditioning inputs (i.e., the material maps 202, and the lighting 204). These embodiments encode the albedo, normal maps (and/or other material maps) and lighting information using one or more neural networks to obtain feature embeddings.

To perform the encoding, one or more embodiments use an encoder path (downsampling) by passing the noisy image (i.e., the noise vector 206) through a series of convolutional layers to extract hierarchical features at different scales. At each layer 1, some embodiments compute the feature map Fl. At each layer 1 of the encoder, various embodiments apply cross-attention to integrate the conditioning features with the feature map Fl. In some embodiments, the cross-attention computation is as follows:

$$Attention ( Q , K , V ) = softmax ( QKT / √ {d}_{k} ) V$$

Where Q (Query)=Feature map Fl from the noisy image, K (Key) and (Value) represent the conditioning features from albedo, normal maps, and/or lighting. This produces a refined feature map that incorporates conditioning information. The lowest resolution layer in the U-Net captures the most abstract features. Various embodiments then integrate global context from the latent variables at this stage to provide additional scene information.

Some embodiments then engage in the decoder path (upsampling) by passing the features through a series of transposed convolutional layers to progressively reconstruct the image 210. Various embodiments use skip connections to combine high-resolution features from the encoder with the upsampled features to preserve spatial details. The final layer of the decoder produces the denoised image, which integrates the noise reduction with the conditioning information to generate the final rendered image 210. Accordingly, the lowest resolution layer in the U-Net captures the most abstract features. Various embodiments also integrate global context from the latent variables at this stage to provide additional scene information. Various embodiments then pass the features through a series of transposed convolutional layers to progressively reconstruct the image. Various embodiments use skip connections to combine high-resolution features from the encoder with the upsampled features to preserve spatial details. The final layer of the decoder produces the denoised image, which integrates the noise reduction with the conditioning information to generate the final rendered image.

Continuing with FIG. 2, numeral 212 indicates that user-initiated video control 212 can be incorporated, which is included in the additional parameters 216. Video control 212 indicates that the DM 208 can handle video inputs, ensuring temporal consistency across frames. Video control 212 allows users to specify (e.g., via natural language or user interface selections) material properties and lighting conditions. Responsively, various embodiments generate the corresponding material maps 211 and the lighting 204, as described, for example, with respect to the material map generator 102 and the lighting map generator 104 of FIG. 1. For example, users can specify, in natural language, that an object in the rendered image 210 should be a particular color throughout the video sequence.

Similarly, the edit/refinement control 214 allows users to edit and refine the rendered output through text control and parameter adjustments for materials. This makes the rendering process accessible to non-professional users by providing intuitive controls for modifying the scene. For example, the DM 208 can adjust the glossiness in proportion to the user statement, “Increase the glossiness of the wooden floor by 20%.” In another example, particular embodiments can change an albedo map based on user input that states “Change the color of the couch from red to blue.” Users can additionally or alternatively replace or modify textures on surfaces, such as changing the pattern on a rug or the fabric on a chair. For example, “Apply a new floral texture to the sofa fabric.” Users can additionally or alternatively adjust the reflectivity and specular highlights on surfaces. For example, users can state “Increase the reflectivity of the marble countertop” to change a material map. Users can also adjust the intensity of light sources in the scene (e.g., via a natural language utterance “Dim the main light source by 30%”). Users can also change the direction of the light to simulate different times of day or lighting setups, such as via the utterance “Shift the sunlight direction to come from the east.” Users can control the softness of shadows to make them harder or softer, such as via the utterance “Soften the shadows cast by the window light.”

To incorporate video control 212 and edit/refinement control 214 into the architecture of the Diffusion Model (DM) 208, in some embodiments the model 208 would need to be augmented with additional modules and mechanisms to handle temporal consistency, dynamic user input, and real-time editing capabilities. For example, the DM may include a spatio-temporal encoder-decoder (not shown), to handle video inputs and maintain temporal consistency across frames. The spatio-temporal encoder would incorporate 3D convolutional layers to process both spatial and temporal information. Various embodiments would then use recurrent layers (e.g. LSTM, GRU, etc.) or temporal convolutional layers to capture temporal dependencies. The spatio-temporal decoder would then use transposed 3D convolutions for upsampling in both spatial and temporal dimensions, and incorporate skip connections to preserve spatial details and maintain consistency. Various embodiments would then integrate temporal attention to focus on relevant features from previous frames. Some embodiments use NLP techniques to parse user inputs and map them to corresponding changes in material properties and lighting. Some embodiments integrate user inputs dynamically during the denoising process using conditional embeddings and cross-attention mechanisms. Some embodiments create embeddings for user-specified changes (e.g., glossiness, color). Some embodiments then apply cross-attention to integrate these embeddings into the intermediate features of the model. By integrating spatio-temporal mechanisms for video control and cross-attention for dynamic user input handling, the diffusion model 208 can achieve both temporal consistency and interactive refinement capabilities. This enhanced architecture allows users to control material properties and lighting in real-time, ensuring high-quality, coherent video outputs.

FIG. 3 illustrates an inverse rendering pipeline 300 where a diffusion model 308 generates one or more material maps 302 as an output based on specific inputs, according to some embodiments. In some embodiments, the noise vector 306 represents the noise vector generated by the noise vector generator 108 of FIG. 1, the DM 308 represents the generative model(s) 112, and the material maps 302 represent the material maps generated by the material map generator 102 of FIG. 1.

FIG. 3 illustrates an intrinsic decomposition inverse rendering process where the DM 308 generates, as an output, material map(s) 302 based on processing, as an input, the input image 303 (e.g., an image uploaded by a user) and the noise vector 306. The input image 303 is from which a user requests to extract intrinsic properties like albedo, normals, and other material maps. The noise vector 306 is added to the input image, which the diffusion model 308 will process to generate the material maps 302. The additional parameters 316 represents additional parameters or conditions that guide the diffusion model. These parameters might include learned weights, prior knowledge, or constraints specific to the task. Intrinsic decomposition refers to the process of separating the input image 303 into its fundamental components that describe different intrinsic properties of the scene. In this context, the intrinsic properties include the material maps 302.

In order to generate the material maps 302 at the output, various functions occur according to some embodiments. The input image I is combined with noise z (i.e., the noise vector 306): X₀=I+z. The noisy image X₀ is then passed through the encoder, which includes several convolutional layers that progressively downsample the image 303 and extract hierarchical features. At each layer of the encoder, cross-attention mechanisms are applied to integrate the conditioning information (e.g., albedo, normal maps, and lighting). The cross-attention mechanism allows the model to focus on relevant parts of the conditioning inputs while processing the noisy image. Abstract features and global context are captured at the lowest resolution layer. Regarding the decoder path, the image 303 is reconstructed through the decoder, with skip connections preserving spatial details. Regarding the output layers, separate convolutional layers produce the material map 302, such as albedo, normal, metallic, and roughness maps. At the final layer of the decoder, the model outputs the different material maps. Each map corresponds to specific intrinsic properties of the input image. By leveraging cross-attention mechanisms within a U-Net architecture, the diffusion model 308 can effectively process the noisy input and generate detailed material maps, maintaining high fidelity and consistency with the input image. In some embodiments, the DM 316 is configured to produce the material maps 302 via the video control 212 and/or the edit/refinement control 214 as described with respect to FIG. 1.

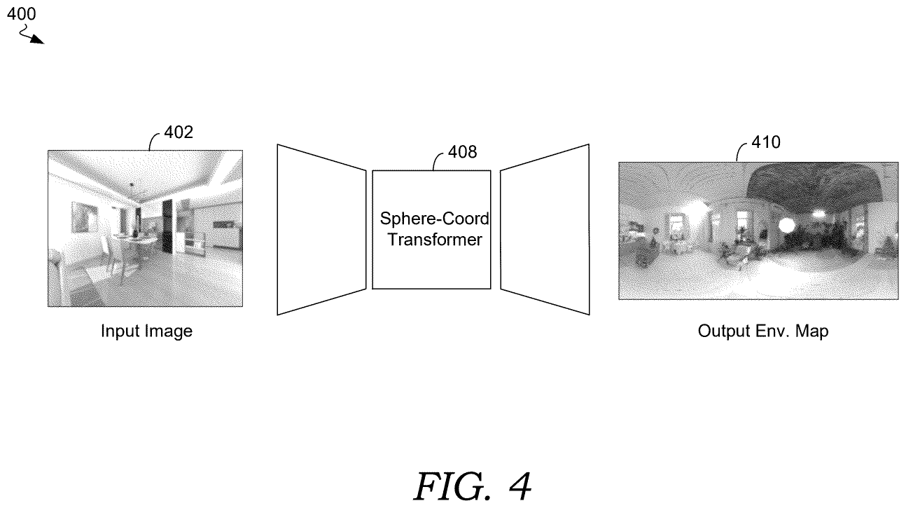

FIG. 4 illustrates an inverse rendering pipeline where a transformer 408 generates an environment map 410 as an output based on specific inputs, according to some embodiments. In some embodiments, the transformer 408 represents the generative model(s) 112 of FIG. 1.

FIG. 4 illustrates a process that involves intrinsic decomposition and lighting estimation/modeling to generate an environment map 410 from an input image 402 using a Sphere-Coord Transformer 408. A “sphere-coord transformer” 408 is transformer model that operates on data represented in spherical coordinates. Spherical coordinates are used to describe points in 3D space (e.g., with three values: radial distance, polar angle, and azimuthal angle). In the context of machine learning or neural networks, a “sphere-coord transformer” 408 a specialized model designed to handle data that naturally fits into a spherical coordinate system. This can be particularly useful in tasks involving 3D spatial data, where traditional Cartesian coordinates (x, y, z) may be less efficient or intuitive.

The input image 402 (e.g., a 2D image) is first processed to extract relevant features. For example, particular embodiments use a convolutional neural network (CNN) to detect and encode features such as edges, textures, and color information. The features extracted from the input image 402 are then mapped to spherical coordinates. This involves transforming the 2D image features into a 3D representation. For instance, each pixel in the image can be projected onto a unit sphere, converting Cartesian coordinates to spherical coordinates (radius r, polar angle θ, and azimuthal angle ϕ). The transformation from Cartesian to spherical coordinates is given by:

$$θ = arccos ( z / √ {x}^{2} + {y}^{2} + {z}^{2} ) \\ ϕ = arctan 2 ( y , x )$$

where (x,y,z) are the Cartesian coordinates, and (θ,ϕ) are the spherical coordinates.

The sphere-coord transformer 408 processes the spherical coordinate data. This transformer model 408 includes layers that use attention mechanisms specifically designed for spherical data. These layers can effectively capture the dependencies and relationships between different parts of the spherical data, which is crucial for tasks like lighting estimation. Using the spherical features processed by the transformer, the model 408 generates an environment map 410. An environment map is a representation of how light interacts with the environment and is used in rendering to simulate realistic lighting conditions. The output map includes information on light sources, their intensities, directions, and colors. Specific loss functions (e.g., Mean Squared Error (MSE) and Structure Similarity Index Loss (SSIM)) are used to ensure the output environment map accurately represents the lighting conditions during fine-tuning or training. These loss functions aim to measure the difference between the predicted environment map and the ground truth lighting conditions. This process leverages the strengths of both CNNs for feature extraction and transformers for processing complex dependencies in spherical data, leading to accurate and realistic environment maps for lighting estimation and modeling.

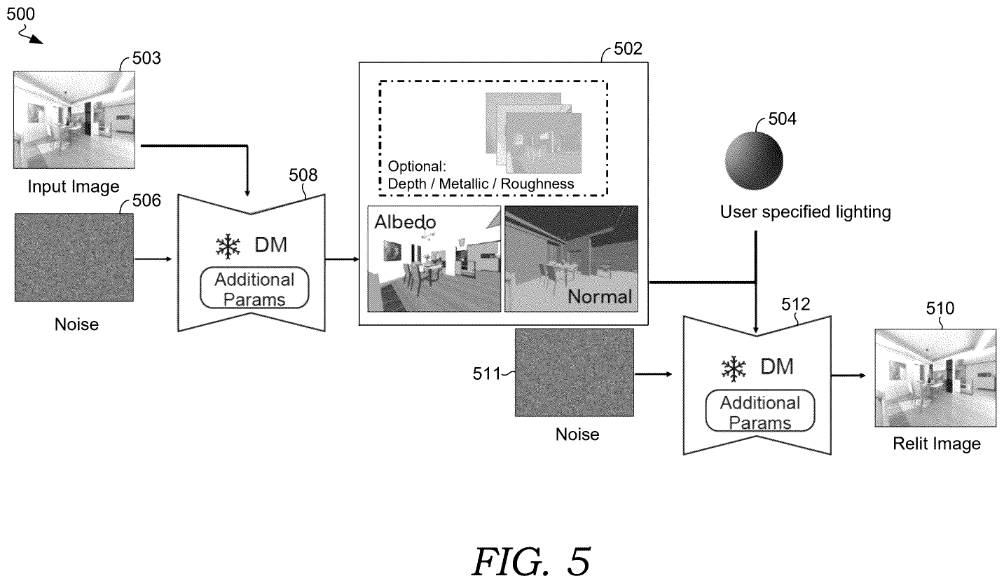

FIG. 5 illustrates a pipeline 500 for performing 2D frame relighting via intrinsic decomposition and neural rendering, according to some embodiments. In some embodiments, the noise vectors 506 and 511 are noise vectors generated by the noise generator 108 of FIG. 1. In some embodiments, the diffusion models 508 and 512 represent the generative model(s) 112 of FIG. 1. In some embodiments, the material maps 502 represent the material maps generated by the material map generator 102 of FIG. 1. In some embodiments, the user-specified lighting 504 represents user input and/or lighting maps generated by the lighting map generator 104 of FIG. 1.

FIG. 5 illustrates an input 2D image 503 that is fed into the pipeline for video relighting, as indicated in the relit image 510. The pipeline 500 involves taking an input image 503 and noise vector 506, processing them through a diffusion model (DM) 508 to extract material maps 503, and then using user-specified lighting 504 to generate a relit image 510.

Specifically, a real-world input image 503 that a user requests to relight (change lighting parameters) is first provided to the DM 508 as input. For example, an image along with a request to change a position of a light source from coordinates A to coordinates B may be provided as input into the DM 508. A noise vector 506 also added to the input image 503 to create an initial noisy input for the diffusion model. As described above, for example, the noise vector z is added to the input image I to create the initial noisy input X₀ (X₀=I+αz) via a forward and/or reverse diffusion process.

The diffusion model 508 processes the input image 503 and noise 506 to decompose the image into its intrinsic properties, including one or more material maps 502. The one or more material maps 502 may include: an Albedo Map (the base color of the surfaces in the scene without any shading or lighting effects), Normal Map (encodes the orientation of the surfaces in the scene), and Optional Maps, which include additional intrinsic properties such as depth, metallic, and roughness can also be extracted if needed. The intrinsic decomposition step involves a neural network that analyzes the input image and separates it into these fundamental components, which are essential for realistic relighting.

As described herein, the DM 508 is trained, updated, or fine-tuned to generate the material maps 502. For example, for training purposes, ground truth albedo maps, normal maps, and optionally other maps (depth, metallic, and roughness) are obtained in a dataset. In some embodiments, the training involves iteratively optimizing the model parameters to minimize the difference between the predicted intrinsic material maps and the ground truth material maps. In a forward pass of training, some embodiments first generate a noise vector z and add it to the input image I: X₀=I+αz. The noisy input X₀ is passed through the encoder to extract features. The decoder processes these features to predict the albedo and normal maps, for example.

Some embodiments define suitable loss functions to measure the reconstruction accuracy of each intrinsic property. For example, with respect to albedo loss, L2 loss (Mean Squared Error) between the predicted and ground truth albedo maps are computed via the equation:

$${L}_{albedo} = ‖ {A}_{pred -} {A}_{true} ‖ 2. \\ \text{?}$$

$$\text{?} \text{indicates text missing or illegible when filed}$$

By following this process, the Diffusion Model 508 learns to decompose input images into their intrinsic properties, effectively handling noise and producing accurate albedo and normal maps, and/or additional material maps.

After the material maps 502 have been generated, these maps, along with user specified lighting 504 and a second noise vector 511 are provided to the second DM 512 as input to produce a final relit image 510. The user provides lighting conditions 504, which are encoded into parameters that the second DM 512 can understand and use. These parameters include the direction, color, and/or intensity of the light sources.

After generation of the material maps, 502, some embodiments generate a noise vector 511 (z) and add it to the material maps 502 to create the initial noisy input. Some embodiments also translate the user-specified lighting conditions 504 into a format that the model can understand, such as a lighting vector or map (e.g., as generated by the lighting map generator 104 of FIG. 1). For example, a user may specify: Lighting Direction: From the top-right corner; Intensity: High intensity (e.g., 1.5 times the ambient light); Color: Warm light (e.g., 3000K color temperature); Type: Point light source.

Various embodiments then use the DM 512 that incorporates the material maps 502, noise 511, and user-specified lighting 504 to generate the relit image 510. For example, some embodiments pass the noisy material maps through an encoder to extract features. In some embodiments, the encoder includes multiple convolutional layers, each followed by non-linear activation functions (e.g., ReLU), and/or other operations like batch normalization. The goal of the encoder is to progressively downsample the input while extracting increasingly abstract and higher-level features. The input to the encoder is a concatenation of the albedo map, the normal map (and/or any other material map), and the noise vector 511. If the albedo and normal maps 502 are each 3×H×W3×H×W tensors (where HH and WW are the height and width of the images), and the noise vector 511 is also 3×H×W3×H×W, the combined input will be a 9×H×W9×H×W tensor.

Each convolutional layer applies a set of learnable filters to the input (corresponding to 511, 502, and 504). The filters are small matrices (e.g., 3×3×3 or 5×5×5) that slide over the input, performing a dot product at each spatial location. For an input tensor X and a filter W, the convolution operation at position (i,j) can be written as:

$${Y}_{i , j , k} = {\sum }_{m = 1}^{c} {\sum }_{n = 1}^{F h} {\sum }_{n = 1}^{F h} {\sum }_{0 = 1}^{F w} {W}_{k , m , n , o} \cdot {X}_{m , i + n , j + o}$$

where Y_{i,j,k} is the output feature map at position (i,j) in channel k, C is the number of input channels, Fh and Fw are the height and width of the filter, and W_{k,m,n,o} are the weights of the filter in channel k. Pooling layers (e.g., max pooling) are used to reduce the spatial dimensions of the feature maps while retaining the most important information. This helps in reducing the computational load and introducing spatial invariance.

Various embodiments then integrate the user-specified lighting 504 with the extracted features using cross-attention or other conditioning mechanisms. The lighting vector influences how the features are processed, ensuring that the new lighting conditions are applied correctly. First, the user-specified lighting conditions 504 are encoded into a form that the model can use. This encoding, for example, involves converting the lighting parameters (e.g., direction, intensity, color) into a feature vector. For example, lighting direction may be encoded as a vector indicating the direction of the light. Intensity may be encoded as a scalar value indicating the intensity of light. Color is encoded as a RGB vector indicating the color of light.

The cross-attention mechanism allows the model 512 to integrate the user-specified lighting 504 into the feature extraction process. This is done by attending to the lighting features while processing the image features. Key (K) and Value (V), of the cross-attention mechanism, for example indicates the encoded lighting information. The cross-attention mechanism computes a weighted sum of the values (V), where the weights are determined by the similarity between the queries (Q) and the keys (K), as described above. The feature map from the encoder, represents the image features. The encoded lighting vector, is reshaped to match the spatial dimensions of the feature map. The feature map extracted by the encoder will have the shape (B,,,), where B is the batch size, Cis the number of channels, H is the height, and W is the width. The lighting vector L is encoded into a higher-dimensional feature vector using a fully connected (FC) layer. If, for example, the lighting vector L has a shape (B,7) where 7 represents the components of the lighting vector (direction x,y,z, intensity, color r,g,b). The encoded lighting vector is transformed into a feature vector using a neural network, such as a series of fully connected layers. The encoded lighting vector is reshaped to match the spatial dimensions of the feature map. In some embodiments, this involves adding two singleton dimensions at the end of the encoded vector, making it compatible for broadcasting. Broadcasting ensures that the lighting vector is replicated across the spatial dimensions of the feature map.

For image reconstruction at the relit image 510, the second diffusion model 512 takes the material maps 502 and user-specified lighting 504 as inputs, along with another noise vector 511. The model 512 uses these inputs to render the final relit image 510, applying the new lighting conditions to the scene. Cross-attention mechanisms ensure that the user-specified lighting is accurately applied to the material maps to generate a realistic relit image 510. The final output is a relit image 510, which appears as if it were illuminated by the new lighting specified by the user at 504.

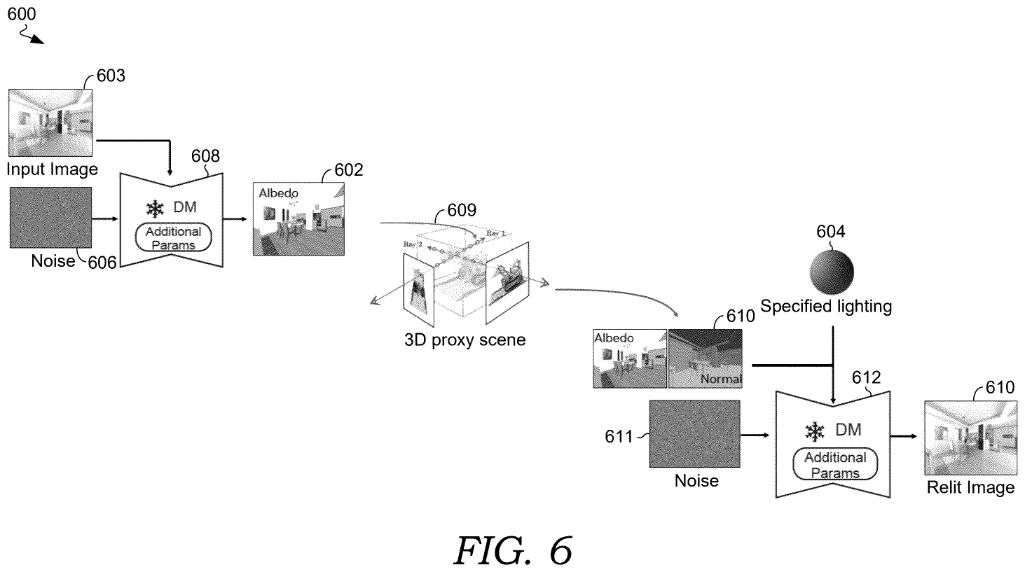

FIG. 6 illustrates a pipeline 600 for performing 3D frame relighting via intrinsic decomposition and neural rendering, according to some embodiments. In some embodiments, the noise vectors 606 and 611 are noise vectors generated by the noise generator 108 of FIG. 1. In some embodiments, the diffusion models 608 and 612 represent the generative model(s) 112 of FIG. 1. In some embodiments, the material maps 602 and/or 610 represent the material maps generated by the material map generator 102 of FIG. 1. In some embodiments, the specified lighting 604 represents user input and/or lighting maps generated by the lighting map generator 104 of FIG. 1.

At a first time, the input image 603 (e.g., a driving video frame, a YOUTUBE video frame, a SORA video frame), along with the noise vector 606 is provided to the DM 608 as input to generate an output albedo material map 602 (e.g., as described with respect to the DM 508 of FIG. 5 or the DM 316 of FIG. 3). At a second time, various embodiments generate a 3D proxy scene 609 based on taking, as input, the albedo map 602 (and/or other material maps). The 2D information (e.g., albedo 602) is used to create a 3D proxy scene 609. This scene represents a 3D reconstruction of the environment depicted in the input image 603.

In an illustrative example, proxy Neural Radiance Fields and/or 3D Geometry Scanning (3DGS) is used to generate the 3D proxy scene 609. Neural Radiance Fields (“NeRFs”) is a technique used to represent a scene in 3D space as a continuous, parameterized function, which can be used to output color and density given a 3D location and 2D viewing direction to render 2D images of any position in the scene. It learns this function by optimizing its parameters to fit a set of 2D images of the scene indicated in the input image 603. The input is the albedo map 603 (provides the base color of surfaces) and/or other material maps (e.g., normal, depth, roughness, etc., to provide additional geometric and surface information).

NeRFs use positional encoding to convert 3D coordinates into a higher-dimensional space. This helps the network capture high-frequency details. Techniques for creating NeRFs typically use a multi-layer perceptron (MLP) to model the scene. Positional encoding transforms the input 3D coordinates into a higher-dimensional space to capture high-frequency variations. This encoding is crucial because standard MLPs struggle to learn high-frequency functions with low-dimensional inputs. The positional encoding function γ maps a 3D coordinate x=(x,,) to a higher-dimensional vector:

$$γ ( x ) = ( sin ( {2}^{0} π x ) , cos ( {2}^{0} π x ) , sin ( {2}^{1} π x ) , cos ( {2}^{1} π x ) , … , sin ( {2}^{L - 1} π x ) , cos ( {2}^{L - 1} πx ) )$$

where L is the number of frequencies used for encoding.

In one or more embodiments, the MLP in a NeRF models the scene by learning to map the positional encoded coordinates and viewing directions to color and density values. In some embodiments, the MLP includes several fully connected layers with ReLU activations. The network takes in the positional encoded coordinates and viewing direction, and outputs the density and color. The MLP takes the encoded 3D coordinates and viewing direction as inputs and outputs the color and density. Volume rendering may be used to generate 2D images from a NeRF. Rays are cast through the scene from a target viewpoint in the scene, and the network predicts color and density information along these rays. The colors and densities are then integrated to produce pixel colors. The network is trained using gradient descent to minimize the difference between the rendered images and the ground truth images. The positional encoding converts 3D coordinates into a higher-dimensional space, encodes viewing directions similarly, enabling the model to consider the direction from which a point is viewed, and provides the MLP with a richer set of features, facilitating the learning of complex, high-frequency patterns in the scene. For a ray r(t)=o+td where o is the origin and d is the direction, the color C(r)C(r) is given by:

$$C ( r ) = {\int }_{tn}^{tf} T ( t ) σ ( r ( t ) ) c ( r ( t ) ) dt$$

where σ(r(t)) is the density at point r(t) and c(r(t)) is the color at point r(t).

3D Geometry Scanning (3DGS) involves reconstructing the 3D geometry of a scene from 2D images, such as 603, using techniques such as photogrammetry or structured light scanning. The input is the albedo map 602 (and/or other material maps, such as a normal map and a depth map (provides distances from the camera to surfaces)).

If multiple views of the scene (input image 603) are available, Multi-view Stereo (MVS) techniques can be used to reconstruct the 3D geometry by finding correspondences between the images and triangulating the 3D points. Structure from Motion (SfM) can be used to estimate the camera parameters and 3D structure of the scene from a sequence of 2D images. If only single-view images are available, depth estimation networks can predict the depth map from the image. The 3D points obtained from MVS or SfM are used to construct a mesh representing the 3D geometry of the scene. The albedo map and other material maps are projected onto the mesh to create a textured 3D model.

In some embodiments, the various training stages occur so that a model can learn to produce 3D proxy scenes given a material map as input. Photometric Loss, which measures the difference between the rendered images and ground truth images, is used. NeRFs can be used with volume rendering techniques to integrate predicted densities and colors along rays to produce pixel colors. Various embodiments use gradient descent to minimize the photometric loss over the training dataset. After training, the model can generate a 3D proxy scene from the albedo map and other material maps. During inference, the trained model takes the albedo map, normal map, and/or other material maps as inputs to generate a 3D proxy scene.

Continuing with FIG. 6, the 3D proxy scene 606 is used as input to produce material maps 602 (albedo, normal, and/or any other material map), which are extracted from the 3D proxy scene 609. The 3D proxy scene 609 is a simplified or intermediate representation of the scene that captures its geometric and material properties. As described above, this scene can be generated using techniques such as Neural Radiance Fields (NeRF) or 3D Geometry Scanning (3DGS).

In some embodiments, a neural network(s) is used to process the rendered information from the 3D proxy scene 609 to generate the desired material maps at 610. In some embodiments, this network includes an encoder to extract features and decoders to generate specific material maps. The encoder extracts features from the 3D proxy scene 609 and captures high-level representations of the scene geometry and material properties in the 3D proxy scene 609. The input to the encoder in some embodiments a multi-channel image or tensor representing the 3D proxy scene. This could include albedo maps, normal maps, depth maps, and other material properties. The encoder uses a series of convolutional layers to process the input. Each convolutional layer applies a set of learnable filters to the input, producing feature maps that capture local patterns and structures. Each layer applies a convolution operation (as described above). Each convolutional layer outputs feature maps that capture different levels of abstraction, such as low-level features (e.g., edges, textures, and simple patterns), mid-level features (e.g., shapes, contours, and structures), and high-level features (e.g., object parts, semantics, and material properties). The deeper layers of the encoder capture high-level representations that combine geometric and material information. These high-level features are useful for tasks like relighting and material map generation.

In some embodiments, separate decoders are used to generate different material maps 610, such as albedo and normal maps. Each decoder is designed to generate one type of material map. The decoder in some embodiments includes a series of transposed convolutional layers (also known as deconvolutional layers) that upsample the feature maps to the original input resolution. An albedo map decoder, for example, takes the high-level features as input and outputs a 3-channel image representing the albedo map. Likewise, a normal map decoder uses a similar architecture but outputs a 3-channel image representing the normal map.

Continuing with FIG. 6, the material maps 610, the noise vector, and the specified lighting condition 604 (e.g., user specifies to change lighting source location) is provided as input to the second DM 612, which then generates a final rendered relit image 610, which represents a 3D relit version of the input image 603. In some embodiments, the DM 612 generates the relit image 610 in an identical manner as described, for example, with respect to the DM 208 of FIG. 2, which also takes, as input, material maps, a noise vector, and lighting, to generate a rendered image 210.

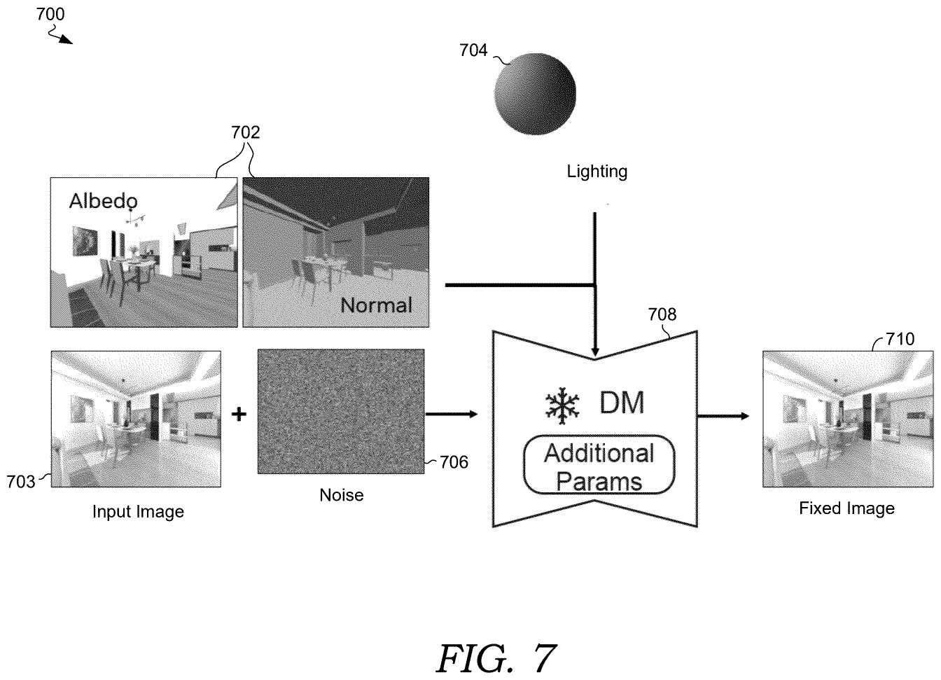

FIG. 7 illustrates a pipeline 700 for providing identify-preserving image enhancements (e.g., object insertion, compositing, or style transfer), according to some embodiments. In some embodiments, the noise vector 706 is generated by the noise generator 108 of FIG. 1. In some embodiments, the diffusion model 708 represents the generative model(s) 112 of FIG. 1. In some embodiments, the material maps 702 and/or 610 represent the material maps generated by the material map generator 102 of FIG. 1. In some embodiments, the specified lighting 704 represents user input and/or lighting maps generated by the lighting map generator 104 of FIG. 1.

The input image 703 (e.g., an image a user provides to request image enhancement or fixing), the albedo map (e.g., map representing the base color of the surfaces in the image), the normal map (e.g., a map representing the surface orientations), random noise 706, and the lighting 706 are provided to the diffusion model (DM) 708 as input. Random noise (represented as noise vector 706) is added to the input image 703, which is used by the diffusion model 708 during the denoising process. In some embodiments, the lighting 704 include Spherical Harmonics (SH), Environment Maps (Env. Map), and/or latent representations, as described herein. This lighting information 704 is used to inform the model about the lighting conditions in the scene indicated in the input image 703. Additional parameters of the DM 708 include parameters for adjusting the style or enhancing specific aspects of the image (e.g., via image inpainting).

The input image 703 is first combined with the noise vector 706 to create a noisy version of the input image 703, which will be used by the diffusion model 708 to enhance (and/or learn how to enhance at training) the image. The albedo and normal maps 702 (and/or any other suitable material maps) provide additional information about the material properties and geometry of the scene, which helps in preserving the identity and improving the realism of the final output at 710.

There are various use cases that can be utilized to generate the fixed image 710 from the input image 703. For example, in some embodiments, simulation-to-reality (Sim2Real) techniques are used to convert synthetic video frame(s) (e.g., from CARLA) to photorealistic video frame(s). The model 708 can take a less photorealistic image (source style), at 703, and use the albedo and normal maps 702 to generate a more realistic image at 710.

In one or more implementations, input may include one or more of a source image, an albedo map, a normal map, etc. A source image (Is) (represented by input image 703) may comprise a less photorealistic image. An albedo map (A) (in 702) represents the base color of the surfaces without lighting or shading. The normal map (N) (in 702) encodes the surface orientations (normals). Noise (η) (i.e., noise vector 706) is added to the input image 703 to create an initial noisy input. The encoder of the DM 708 processes the input image 703, albedo map 702, normal map 702, and noise 706 to extract meaningful features.

In one or more implementations, the feature extraction may be achieved by using a function F of the encoder that takes the concatenated input and extracts features:

$${F}_{enc} = F ( {I}_{s} , A , N , η )$$

where F_{enc} represents the extracted features.

Lighting information (L) (represented by 704) such as spherical harmonics, environment maps, and/or latent vectors are integrated into the feature extraction process using cross-attention or another conditioning mechanism, as described above. Let L_{enc} be the encoded lighting information. The integrated feature Fᵢₙₜ is computed as: Fᵢₙₜ=Attention (F_{enc},L_{enc},L_{enc}). The decoder of the DM 708 takes the integrated features and reconstructs the image 703 with enhanced photorealism: Iᵣ=G(Fᵢₙₜ), where G is the function of the decoder, and Ir is the resulting more photorealistic image (represented by 710).

To ensure that the output image Ir is photorealistic and retains the identity of the source image in 703, the model 708 is trained using multiple loss functions, in some embodiments. For example, reconstruction loss can be used. Reconstruction loss measures the difference between the predicted image (e.g., in 710) and the ground truth photorealistic image (I_{gt}):

$${L}_{rec} = ‖ {I}_{r} - {I}_{gt} ‖ 2.$$

Some embodiments additionally or alternatively use perceptual loss. With this loss, a pre-trained network (e.g., a DM) is used to measure the perceptual similarity between Iᵣ and I_{gt}:

$${L}_{perc =} i \sum ‖ {ϕ}_{i} ( {I}_{r} ) - {ϕ}_{i} ( {I}_{g t} ) ‖ 2$$

where ϕi denotes the feature maps from the i-th layer of the pre-trained network. Additional or alternative losses may be used, such as lighting consistency loss and/or style loss. The total loss is a weighted sum of the above losses:

$${L}_{total} = {λ}_{rec} {L}_{rec} + {λ}_{perc} {L}_{perc} + {λ}_{style} {L}_{style} + {λ}_{light} {L}_{light}$$

where λ_{rec}, λ_{perc}, λ_{style}, and λ_{light} are weights for each loss component. In some embodiments, the model parameters are optimized to minimize this total loss using gradient descent methods such as Adam.

Some embodiments additionally or alternatively change the style of the input image 703 while preserving the underlying geometry and materials (e.g., the material maps). For example, various embodiments apply a different artistic style to the image 703. Let Source Image (Iₛ) (e.g., input image 703) represent the image whose style is to be changed. Let image style (I_{style}) represent the image providing the desired style (e.g., fixed image 710).

In these style transfer embodiments, the encoder of the DM 708 extracts features from the style image to capture the stylistic elements: F_{style}=F(I_{style}). To transfer the style from I_{style} to Iₛ, various embodiments transform the features F_{enc} (encoder features) of the source image to match the style features F_{style}. Some embodiments utilize Adaptive Instance Normalization (AdaIN), which adjusts the mean and variance of the content features to match those of the style features.

$$AdaIN ( {F}_{enc} , {F}_{style} ) = σ ( {F}_{style} ) ( {F}_{enc} - μ ( {F}_{enc} ) / σ ( ( {F}_{enc} ) ) + μ ( {F}_{style} )$$

where μ and α represent the mean and standard deviation, respectively. The decoder takes the transformed features and reconstructs the image with the desired style while preserving the underlying geometry and material properties. Thus, the transformed features Fₜᵣₐₙₛ are given by: Ir=G(Fₜᵣₐₙₛ), where G is the function of the decoder, and Iᵣ is the resulting styled image.

To ensure that the output image Ir has the desired style and retains the underlying geometry and materials of the source image, the model 708 is trained using multiple loss functions in some embodiments. For example, content loss (measures the difference between the features of the source image 703 and the reconstructed image 710, ensuring the geometry and material properties are preserved), style loss, material consistency loss (ensures that the material properties (e.g., albedo and normal maps) are consistent between the source image and the styled image in 710)) is used. This can be achieved by comparing the reconstructed material maps from the styled image with the original material maps. The total loss is a weighted sum of the above losses. The model parameters are optimized to minimize this total loss using gradient descent methods such as Adam.

Some embodiments additionally or alternatively perform composting and/or object insertion. Consider the following notation: input image 703 (Iₛ): the original image of the scene, albedo map (Aₛ), normal map (Nₛ), object image (Iₒ): representing an image of the object (e.g., a couch) to be inserted into the scene, object albedo map (A₀): represents the base color of the object's (to be inserted) surfaces, object normal map (Nₒ): encodes the surface orientations of the object. Object mask (M₀): A binary mask indicating the presence of the object in the composite image. Lighting information (L): includes spherical harmonics, environment maps, and/or latent representations. The aim is to integrate Iₒ into Iₛ to create a composite image I_{c} (e.g., the fixed image 710) that looks photorealistic and consistent with the scene's lighting and material properties.

The encoder processes both the scene and the object images along with their respective albedo and normal maps to extract meaningful features. The lighting information (L) is encoded to inform the model about the lighting conditions in the scene. A cross-attention mechanism is used to integrate the features of the object with the scene features while considering the lighting conditions. This ensures that the object's appearance is adjusted to match the scene's lighting. This allows the object features to be conditioned on both the lighting and the scene context. The integrated features Fᵢₙₜ are then used to generate the composite image at 710. The object mask Mₒ is used to blend the object into the scene. The compositing can be expressed as:

$${F}_{comp} = {F}_{s} ⊙ ( 1 - {M}_{o} ) + {F}_{int} ⊙ {M}_{o}$$

where ⊙ denotes element-wise multiplication.

The decoder processes the composited features F_{comp} to generate the final composite image I_{c}: I_{c}=G(F_{comp}). To ensure the composite image is photorealistic and seamless, one or more loss functions are employed during training. For example, as described above, loss functions can include reconstruction loss, perceptual loss, style loss, lighting consistency loss (ensures that the lighting conditions in the composite image are consistent with the specified lighting). In some embodiments, the total loss is a weighted sum of the above losses. The model parameters are optimized to minimize this total loss using gradient descent methods such as Adam.

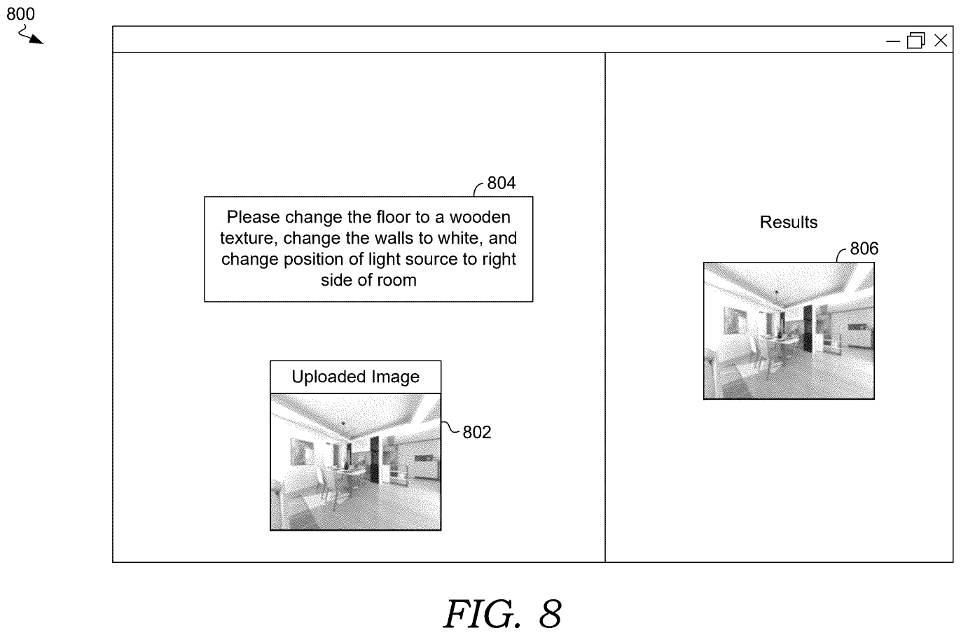

FIG. 8 is a screenshot 800 of an example user interface for editing an input image via inverse rendering, according to some embodiments. The screenshot 800 may correspond to an application that allows users to upload and edit photographs to see how different materials (e.g., floors, walls), products, such as furniture or decorations, or other properties would look in their home. The application needs to accurately understand the lighting and material properties of the user's room to integrate new objects or other properties seamlessly. At a first time, various embodiments receive an upload of an uploaded image 802 (e.g., input image 303 of FIG. 3), which represents what a room currently looks like.

The user may desire to change: the floor from a tile surface in the uploaded image 802 to a wooden texture, the walls from green in the uploaded image 802 to white, and change the position of a light source from the left side of the room to the right side of the room. Accordingly, various embodiments receive corresponding natural language characters in the text field 804 and engage in natural language processing (NLP) to generate entities or other inputs that a model (e.g., the DM 308) processes in order to generate material maps (e.g., material maps 302 of FIG. 3), lighting maps, and/or an output rendered image (e.g., the environment map 410 of FIG. 4). Such natural language characters or other user input (e.g., selection of buttons) represents, in some embodiments, the user input processed by the lighting map generator 104, the material map generator 102, and/or the generative model(s) 112 as described with respect to FIG. 1. For example, the DM 308 may generate multiple material maps as the results 806 representing some property of the wooden floor—e.g., an albedo map (represents the base color of the wood floor, including the natural variations in the wood grain and any stains or finishes. This map does not include lighting information, only the inherent color of the material), normal map (encodes the surface details and small-scale geometry of the wood floor, such as the texture of the grain and any imperfections or patterns. This map affects how light interacts with the surface, creating the illusion of depth and texture), roughness map (indicates the microsurface detail of the wood, specifying how rough or smooth different areas are. For a glossy finish, the roughness map would show low roughness values, meaning the surface is smooth and reflective. For a more natural, matte finish, higher roughness values would be used), specular map (defines the intensity of specular reflections on the wood surface. This map helps to simulate the shininess and reflective properties of the wood finish. For a wood floor with a glossy finish, the specular map would have higher values where the wood is most reflective), displacement Map (Height Map; represents the actual height variations of the wood surface. This map can be used to create physical depth in the rendering process, especially for rendering techniques that support displacement mapping. It highlights the grooves, knots, and other height variations in the wood), ambient occlusion map (encodes the occlusion (shadowing) effects that occur in the crevices and corners of the wood floor. This map enhances the perception of depth and detail by darkening areas where light would naturally be obstructed.

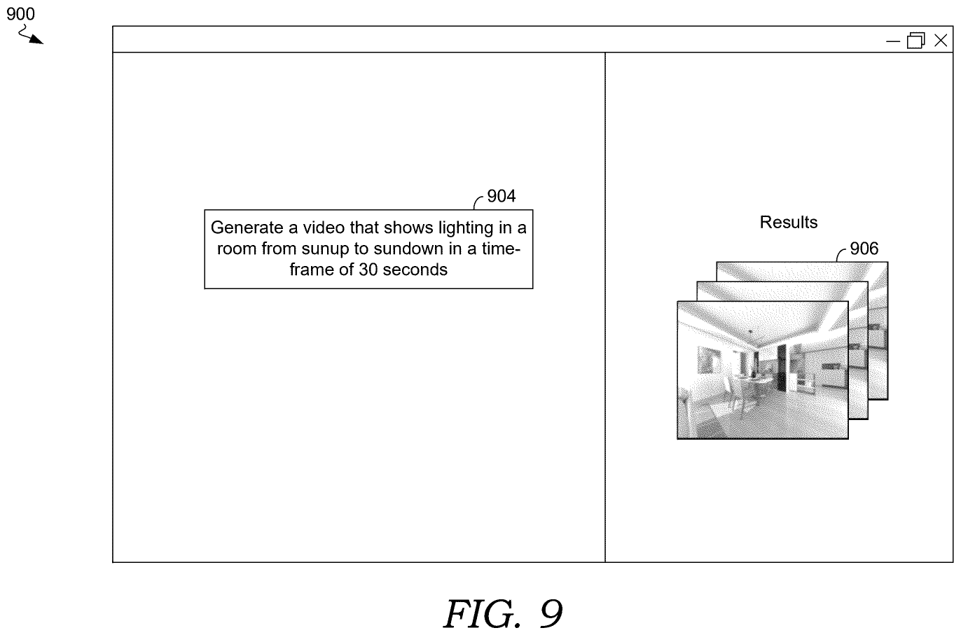

FIG. 9 is a screenshot 900 of an example user interface for generating video frames via rendering, according to some embodiments. The screenshot 900 may correspond to an application that allows users to generate video according to their natural language requests. At a first time, various embodiments receive the user input indicated in the field 904—a request to generate a video of a room that shows lighting in a room from sun up to sun down in a time-frame of 30 seconds. In some embodiments, such user input represents the video control 212 of FIG. 2 and the lighting “from sun up to sun down” represents the lighting condition 204 of FIG. 2. In some embodiments, the “in a time-frame of 30 seconds” represents an additional condition that the DM 208 receives as the additional parameters 216. According, after particular embodiments receive such natural language input, some embodiments generate the corresponding material maps 202, the lighting, 204, and the noise vector 206, and then the DM 208 takes all of these inputs, including the video control 212, to generate the rendered image 212 or the output frames 906, which represents the user input in 904—a generated video of lighting in a room from sun up to sun down in a time-frame of 30 seconds. In other words, some embodiments generate not just a single frame, but a series of frames representing a video sequence that make up the components of a video.

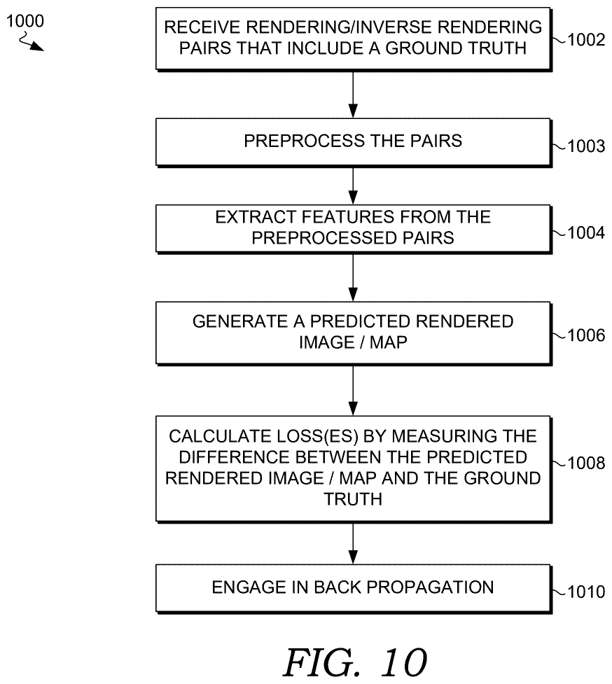

FIG. 10 is a flow diagram of an example process 1000 for training or fine-tuning a machine learning model, according to some embodiments. In some embodiments, the method 1000 represents how the DMs or any other model described herein is fine-tuned. Each block of method 1000 (and/or 11000), described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 1000 (and/or 1100) is described, by way of example, with respect to the generative model(s) 112 system of FIG. 1. However, these methods may additionally or alternatively be executed by any one system, or any combination of systems, including, but not limited to, those described herein.

Per block 1002, some embodiments first receive rendering and/or inverse rendering pairs that include a ground truth. In the context of training a rendering/inverse rendering model, pairs in the training data denote combinations of inputs and their corresponding outputs (that represent a ground truth). These pairs are useful for supervised learning, where the model learns to map the inputs to the correct outputs by minimizing the difference between the predicted outputs and the ground truth outputs. “Rendering pairs” include input-output (ground truth) pairs, such as material map-rendered image (ground truth) pairs, lighting map-rendered image pairs, user input—rendered image pairs, and/or noise-rendered image pairs, where at least the rendered image represents a ground truth. In some embodiments, such pairs are positive and/or negative pairs where positive pairs represent the particular material maps, noise vectors, lighting, and/or user input that correctly belongs to or matches a given ground truth rendered image. Negative pairs represent particular material maps, noise vectors lighting, and/or user input that does not correctly belong to or does not match a given ground truth rendered image. Negative pairs can be used to ensure the model does not overfit to incorrect attributes. The model learns to distinguish when the attributes do not match the noisy image and thus predict higher errors. This helps the model to be more robust and accurate in conditioning on the correct attributes. Using positive and negative pairs thus provides robustness through the use of both matching (positive) and non-matching (negative) pairs during training.

In some embodiments, “inverse rendering pairs” include example input-output (ground truth) pairs, such as input image-rendered image pairs (ground truth), input image-material map pairs (ground truth), noise-material map pairs (ground truth), and/or input image-environment map pairs (ground truth), where at least the material maps, rendered image, and/or environment map (and/or lighting maps) represents a ground truth.

Per block 1003, some embodiments then preprocess the pairs received at block 1002. For example, some embodiments normalize the material maps, images, and other inputs of the pairs. Additionally or alternatively, some embodiments convert user input text into suitable embeddings using an NLP model (e.g., WORD2VEC). For example, BERT (Bidirectional Encoder Representations from Transformers) generates context-aware embeddings for sentences and phrases. Additionally or alternatively, particular embodiments tokenize the user input (e.g., break words or other character fragments into their constituent parts before converting into an embedding). Additionally or alternatively, images themselves may be converted from pixel form into numerical representations for further processing, such as a feature vector and/or a matrix representing particular pixel values.

Per block 1004, some embodiments then extract one or more features from the preprocessed pairs. For example, as described herein, some embodiments apply convolutional neural networks (CNNs) to extract feature representations from inputs of the rendering/inverse rendering pairs. For instance, an encoder of the CNN extracts features from the combined input of albedo, normal maps, and noise by progressively downsampling the input (of the pairs) while extracting high-level features. The output of the encoder is a feature map that captures the essential information needed for predictions at block 1006.

Per block 1006, some embodiments then generate a predicted rendered image and/or a map (e.g., a material map or lighting map). Some embodiments take all of the inputs from the rendering and/or inverse rending pairs (and/or new inputs not in the pairs) to predict a new output. For example, the model predicts the noise (or the clean image). In denoising tasks, the goal is to predict either the noise that was added to the original clean image or to predict the clean image directly from the noisy input. The model is trained to minimize the difference between its predictions and the ground truth.

Per block 1008, some embodiments then calculate one or more losses by measuring the difference between the predicted rendered image/map and the ground truth. This ensures that the predicted rendered output image (or other output, such as material map) adheres to both the graphical attributes (material maps), the textual description, and/or the input image conditions. For example, as described herein, various embodiments compute reconstruction loss, conditioning loss, temporal consistency, and/or a combined loss (a concatenation or sum of all other losses), as described herein. For example, some embodiments compute a temporal consistency loss as follows:

$$L temporal = {\sum }_{i = 1}^{n - 1} {‖ {\hat{x}}_{1} - {\hat{x}}_{1} + 1 ‖}^{2}$$

Temporal consistency loss ensures that the frames generated at consecutive time steps are consistent. With respect to one or more of these losses, the model is trained to minimize a loss function that includes the temporal consistency error, reconstruction error, and/or the conditioning constraints, ensuring the generated images (or other outputs, such as material maps) are realistic and adhere to specified conditions, such as textual and material map conditions.

Per block 1010, some embodiments then engage in back propagation, as described herein. Back propagation is indicative of computing gradients and updating model parameters using the optimizer (e.g., training the model via various additional epochs). For example, some embodiments compute gradients of the total loss with respect to the model parameters by updating the model parameters (e.g., weights and biases) using an optimizer (e.g., Adam) to minimize the total loss. In other words, each layer of a neural network (or node of a neural network) applies a linear transformation (weights and biases) followed by a (e.g., non-linear) activation function to the input data. This process results in a set of outputs that are then used to compute the loss. The difference between the predicted outputs and the ground truth is computed using a loss function (e.g., Mean Squared Error, Cross-Entropy).

The loss value quantifies how well the model's predictions match the actual values. The loss is propagated backward through the network to compute gradients. Gradients represent the partial derivatives of the loss with respect to each parameter in the network (weights and biases). If the input to a neuron (after applying the weights and adding the bias) results in a high value, the neuron is activated (e.g., via activation functions such as ReLU, Sigmoid, and/or Tanh). If the input results in a low or negative value (depending on the activation function), the neuron is inhibited (i.e., its output is zero or near zero). Optimizers adjust the weights based on the gradients computed during backpropagation.

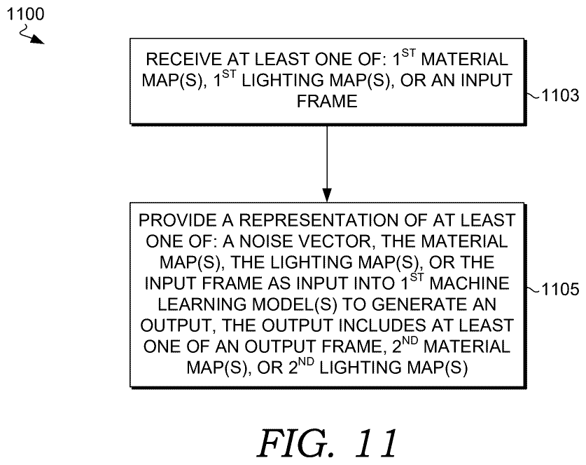

FIG. 11 is a flow diagram of an example process 1100 for generating an output frame or map, according to some embodiments. Per block 1103, some embodiments receive at least one of: a first set of one or more material maps, a first set of one or more lighting maps, and/or an input frame. The one or more material maps define how one or more properties vary across a surface of one or more objects. The one or more lighting maps represent at least one of one or more shading or lighting characteristics associated with the one or more objects. In some embodiments, any material map described herein includes at least one of: an albedo map, a normal map, a roughness map, a metallic map, an ambient occlusion map, a displacement map, a specular map, an emissive map, an opacity map, a cavity map, or a subsurface scattering map.

In one or more embodiments, an albedo map represents the base color of the surface without any shading or lighting effects. It captures the inherent color of the material. For example, for a wooden surface, it shows the natural wood grain and color. It does not include any reflections, shadows, or highlights. The normal map encodes the direction of surface normals, which are vectors perpendicular to the surface. This map is used to create the illusion of complex surface details without adding extra geometry. It affects how light interacts with the surface, creating detailed textures such as bumps, grooves, and wrinkles. The RGB values in the normal map represent the XYZ components of the normal vectors. The roughness map indicates the microsurface texture of the material, determining how rough or smooth the surface appears. This map controls the reflectivity of the surface. Lower roughness values indicate a smooth, shiny surface (e.g., polished metal), while higher roughness values indicate a rough, matte surface (e.g., untreated wood). The metallic map specifies whether the surface is metallic or non-metallic (dielectric). This metallic map uses binary or grayscale values to differentiate metallic and non-metallic areas. Metallic surfaces reflect light differently compared to non-metallic surfaces. Pure metals have high reflectivity and conduct electricity, while dielectrics do not.

The ambient occlusion map encodes the occlusion or shadowing effects in the small crevices and corners of the surface. This map simulates the soft shadows that occur in areas where ambient light is occluded or blocked. It adds depth and realism to the scene by darkening these occluded areas, enhancing the perception of depth and detail. Displacement (height) maps represent the actual height variations of the surface. Unlike normal maps, which only affect lighting, displacement maps modify the geometry of the surface itself. This map is used to create actual geometric detail, such as deep cracks or raised surfaces, by displacing vertices along the normal direction based on the height values.

The specular map defines the intensity and color of specular reflections. It determines the brightness and color of specular highlights, which are reflections of light sources on the surface. The emissive map specifies the areas of the surface that emit light. This map is used to make certain parts of the material glow, independent of external lighting. The emissive map defines the color and intensity of the emitted light, useful for creating effects like glowing screens, lights, or other self-illuminating surfaces.

The opacity map (Alpha Map) defines the transparency of the surface. This map uses grayscale values to indicate how transparent or opaque a surface is. White areas are fully opaque, black areas are fully transparent, and shades of gray represent partial transparency. This is useful for materials like glass, curtains, or foliage. The cavity map highlights small crevices and cavities on the surface. Similar to ambient occlusion, but typically used for smaller details. It enhances the fine details by darkening the cavities and adding more visual depth to the surface. The subsurface scattering map controls how light penetrates and scatters within a translucent material. This map is used for materials like skin, wax, or marble, where light enters the surface, scatters beneath it, and exits at a different point. It helps in simulating the soft, diffused look characteristic of such materials.

Some embodiments receive natural language user input requesting at least one of a material property or a lighting condition to be incorporated into the output frame. Examples of this are described with respect to the fields 804 and 904 of FIGS. 8 and 9 respectively, or the user specified lighting 504 of FIG. 5. And based at least in part on the natural language user input, some embodiments generate at least one of the one or more material maps or the one or more lighting maps, and wherein the output frame is generated based at least in part on the natural language user input, as described, for example, in FIG. 5.

Per block 1105, some embodiments provide a representation (e.g., a tokenized user input, a vector, or matrix) of at least one of: a noise vector, the first material map(s), the lighting map(s), or the input frame into a first machine learning model(s) to generate an output, where the output includes at least one of an output frame second material map(s), or second lighting map(s). Examples of block 1105 are described with respect to the pipelines described with respect to FIG. 2, FIG. 3, FIG. 4, FIG. 5, FIG. 6, and FIG. 7. For example, some embodiments provide a first noise vector (e.g., 206) and a representation of at least one of the one or more material maps (e.g., 202) or the or more lighting maps (e.g., 204) as input into one or more first machine learning models (e.g., the DM 208) to generate an output frame (e.g., the rendered image 210). A “representation” of any payload (e.g., input frame, material map, or noise vector) described herein represents the payload itself (e.g., all of the pixel values of an input image or map) or some other encoded or numerical representation that represents the payload, such as a vector, matrix, or the like.

The first noise vector corresponds to an initial starting point for a diffusion process performed by the one or more first machine learning models. Diffusion models are a type of generative model that learns to generate data (such as images) by reversing a diffusion process. This involves starting with a noise vector and progressively denoising it to produce a final, coherent image. The process can be understood as follows: forward diffusion adds noise to the data (e.g., material maps 202 and/or input image 303) in multiple steps, gradually transforming the data into pure noise. Reverse diffusion trains the model to reverse the forward process, starting from pure noise and iteratively refining it to recover the original data. A noise vector is the initial input to the reverse diffusion process. It is a randomly generated tensor that serves as the starting point from which the model will generate the final image, such as rendered image 210.

A “frame” as described herein refers to a single video frame, a digital image (e.g., a digital photograph), or other unit/format of digital media. A video frame is a single still image in a sequence of consecutive images that, when played in rapid succession, creates the appearance of motion or a video.

As described herein, various embodiments perform various combinations of computations. For example, some embodiments receive an input frame (e.g., 303) and a second noise vector (e.g., 306). Some embodiments then provide the second noise vector and a representation of the input frame and as input into one or more second machine learning models (e.g., the DM 308) to generate the one or more first material maps (e.g., material maps 502), as described in FIG. 3, for example.

Some embodiments provide an input frame (e.g., 703) as input into the one or more first machine learning models (e.g., DM 708), and wherein the first noise vector represents a noisy version of the input frame. Some embodiments then receive a request to enhance the input frame (e.g., as indicated in the field 804 of FIG. 8) (e.g., provide image style transfer, image inpainting, insert an object, Sim2Real, etc.). The output frame (e.g., 710) is generated based at least in part on the request and providing of the input frame as input into the one or more first machine learning models. The output frame includes one or more features that have been enhanced relative to the input frame, as described, for example, with respect to FIG. 7 and FIG. 8.

Some embodiments provide a two-dimensional input frame (e.g., 503) and a second noise vector (e.g., 506) as input into one or more second machine learning models (e.g., DM 508). And based at least on providing the two-dimensional input frame and the second noise vector as input into the one or more second machine learning models, some embodiments generate the one or more material maps (e.g., the material maps 502). In this way, the output frame (e.g., 510) represents the two-dimensional input frame except that a lighting property has been modified in the output frame relative to the input frame, as described, for example, in FIG. 5.

Some embodiments provide a two-dimensional input frame (e.g., 603) and a second noise vector (e.g., noise vector 606) as input into one or more second machine learning models (e.g., DM 608). Based at least in part on providing the input frame and the second noise vector as input into the one or more second machine learning models, some embodiments generate one or more second material maps (e.g., the albedo map 602), as described, for example with respect to 603, 606, 608, and 602 of FIG. 6.

Some embodiments generate a multidimensional frame (e.g., the 3D proxy scene 609 of FIG. 6) based on the generating of the one or more second material maps (e.g., the albedo map 602). The multidimensional frame represents the two-dimensional input frame (e.g., the input image 603) except that the multidimensional frame includes at least one more dimension relative to the two-dimensional input frame. Some embodiments then generate the one or more first material maps (e.g., the material maps 610 of FIG. 6) based at least in part on generating the multidimensional frame. The output frame (e.g., the relit image 610) is then generated based at least in part on generating the multidimensional frame. Such functionality is described with respect to FIG. 6.

### Example Autonomous Vehicle

FIG. 12A is an illustration of an example autonomous vehicle 1200, in accordance with some embodiments of the present disclosure. The autonomous vehicle 1200 (alternatively referred to herein as the “vehicle 1200”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1200 may be capable of functionality in accordance with one or more of Level 3-Level 5 of the autonomous driving levels. The vehicle 1200 may be capable of functionality in accordance with one or more of Level 1-Level 5 of the autonomous driving levels. For example, the vehicle 1200 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1200 or other machine, such as being fully autonomous, being highly autonomous, being conditionally autonomous, being partially autonomous, providing assistive autonomy, being semi-autonomous, being primarily autonomous, or other designation.

The vehicle 1200 may include components such as a chassis, a vehicle body, wheels (e.g., 2, 4, 6, 8, 18, etc.), tires, axles, and other components of a vehicle. The vehicle 1200 may include a propulsion system 1250, such as an internal combustion engine, hybrid electric power plant, an all-electric engine, and/or another propulsion system type. The propulsion system 1250 may be connected to a drive train of the vehicle 1200, which may include a transmission, to allow the propulsion of the vehicle 1200. The propulsion system 1250 may be controlled in response to receiving signals from the throttle/accelerator 1252.

A steering system 1254, which may include a steering wheel, may be used to steer the vehicle 1200 (e.g., along a desired path or route) when the propulsion system 1250 is operating (e.g., when the vehicle is in motion). The steering system 1254 may receive signals from a steering actuator 1256. The steering wheel may be optional for full automation (Level 5) functionality.

The brake sensor system 1246 may be used to operate the vehicle brakes in response to receiving signals from the brake actuators 1248 and/or brake sensors.

Controller(s) 1236, which may include one or more system on chips (SoCs) 1204 (FIG. 12C) and/or GPU(s), may provide signals (e.g., representative of commands) to one or more components and/or systems of the vehicle 1200. For example, the controller(s) may send signals to operate the vehicle brakes via one or more brake actuators 1248, to operate the steering system 1254 via one or more steering actuators 1256, to operate the propulsion system 1250 via one or more throttle/accelerators 1252. The controller(s) 1236 may include one or more onboard (e.g., integrated) computing devices (e.g., supercomputers) that process sensor signals, and output operation commands (e.g., signals representing commands) to allow autonomous driving and/or to assist a human driver in driving the vehicle 1200. The controller(s) 1236 may include a first controller 1236 for autonomous driving functions, a second controller 1236 for functional safety functions, a third controller 1236 for artificial intelligence functionality (e.g., computer vision), a fourth controller 1236 for infotainment functionality, a fifth controller 1236 for redundancy in emergency conditions, and/or other controllers. In some examples, a single controller 1236 may handle two or more of the above functionalities, two or more controllers 1236 may handle a single functionality, and/or any combination thereof.

The controller(s) 1236 may provide the signals for controlling one or more components and/or systems of the vehicle 1200 in response to sensor data received from one or more sensors (e.g., sensor inputs). The sensor data may be received from, for example and without limitation, global navigation satellite systems (“GNSS”) sensor(s) 1258 (e.g., Global Positioning System sensor(s)), RADAR sensor(s) 1260, ultrasonic sensor(s) 1262, LiDAR sensor(s) 1264, inertial measurement unit (IMU) sensor(s) 1266 (e.g., accelerometer(s), gyroscope(s), magnetic compass(es), magnetometer(s), etc.), microphone(s) 1296, stereo camera(s) 1268, wide-view camera(s) 1270 (e.g., fisheye cameras), infrared camera(s) 1272, surround camera(s) 1274 (e.g., 360 degree cameras), long-range and/or mid-range camera(s) 1298, speed sensor(s) 1244 (e.g., for measuring the speed of the vehicle 1200), vibration sensor(s) 1242, steering sensor(s) 1240, brake sensor(s) (e.g., as part of the brake sensor system 1246), one or more occupant monitoring system (OMS) sensor(s) 1201 (e.g., one or more interior cameras), and/or other sensor types.

One or more of the controller(s) 1236 may receive inputs (e.g., represented by input data) from an instrument cluster 1232 of the vehicle 1200 and provide outputs (e.g., represented by output data, display data, etc.) via a human-machine interface (HMI) display 1234, an audible annunciator, a loudspeaker, and/or via other components of the vehicle 1200. The outputs may include information such as vehicle velocity, speed, time, map data (e.g., the High Definition (“HD”) map 1222 of FIG. 12C), location data (e.g., the vehicle's 1200 location, such as on a map), direction, location of other vehicles (e.g., an occupancy grid), information about objects and status of objects as perceived by the controller(s) 1236, etc. For example, the HMI display 1234 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1200 further includes a network interface 1224 which may use one or more wireless antenna(s) 1226 and/or modem(s) to communicate over one or more networks. For example, the network interface 1224 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1226 may also allow communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 12B is an example of camera locations and fields of view for the example autonomous vehicle 1200 of FIG. 12A, in accordance with some embodiments of the present disclosure. The cameras and respective fields of view are one example embodiment and are not intended to be limiting. For example, additional and/or alternative cameras may be included and/or the cameras may be located at different locations on the vehicle 1200.

The camera types for the cameras may include, but are not limited to, digital cameras that may be adapted for use with the components and/or systems of the vehicle 1200. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1200 (e.g., front-facing cameras) may be used for surround view, to help identify forward facing paths and obstacles, as well aid in, with the help of one or more controllers 1236 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1270 that may be used to perceive objects coming into view from the periphery (e.g., pedestrians, crossing traffic or bicycles). Although only one wide-view camera is illustrated in FIG. 12B, there may be any number (including zero) of wide-view cameras 1270 on the vehicle 1200. In addition, any number of long-range camera(s) 1298 (e.g., a long-view stereo camera pair) may be used for depth-based object detection, especially for objects for which a neural network has not yet been trained. The long-range camera(s) 1298 may also be used for object detection and classification, as well as basic object tracking.

Any number of stereo cameras 1268 may also be included in a front-facing configuration. In at least one embodiment, one or more of stereo camera(s) 1268 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1268 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1268 may be used in addition to, or alternatively from, those described herein.

Cameras with a field of view that include portions of the environment to the side of the vehicle 1200 (e.g., side-view cameras) may be used for surround view, providing information used to create and update the occupancy grid, as well as to generate side impact collision warnings. For example, surround camera(s) 1274 (e.g., four surround cameras 1274 as illustrated in FIG. 12B) may be positioned to on the vehicle 1200. The surround camera(s) 1274 may include wide-view camera(s) 1270, fisheye camera(s), 360 degree camera(s), and/or the like. Four example, four fisheye cameras may be positioned on the vehicle's front, rear, and sides. In an alternative arrangement, the vehicle may use three surround camera(s) 1274 (e.g., left, right, and rear), and may leverage one or more other camera(s) (e.g., a forward-facing camera) as a fourth surround view camera.

Cameras with a field of view that include portions of the environment to the rear of the vehicle 1200 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1298, stereo camera(s) 1268), infrared camera(s) 1272, etc.), as described herein.

Cameras with a field of view that include portions of the interior environment within the cabin of the vehicle 1200 (e.g., one or more OMS sensor(s) 1201) may be used as part of an occupant monitoring system (OMS) such as, but not limited to, a driver monitoring system (DMS). For example, OMS sensors (e.g., the OMS sensor(s) 1201) may be used (e.g., by the controller(s) 1236) to track an occupant's and/or driver's gaze direction, head pose, and/or blinking. This gaze information may be used to determine a level of attentiveness of the occupant or driver (e.g., to detect drowsiness, fatigue, and/or distraction), and/or to take responsive action to prevent harm to the occupant or operator. In some embodiments, data from OMS sensors may be used to allow gaze-controlled operations triggered by driver and/or non-driver occupants such as, but not limited to, adjusting cabin temperature and/or airflow, opening and closing windows, controlling cabin lighting, controlling entertainment systems, adjusting mirrors, adjusting seat positions, and/or other operations. In some embodiments, an OMS may be used for applications such as determining when objects and/or occupants have been left behind in a vehicle cabin (e.g., by detecting occupant presence after the driver exits the vehicle).

FIG. 12C is a block diagram of an example system architecture for the example autonomous vehicle 1200 of FIG. 12A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1200 in FIG. 12C are illustrated as being connected via bus 1202. The bus 1202 may include a Controller Area Network (CAN) data interface (alternatively referred to herein as a “CAN bus”). A CAN may be a network inside the vehicle 1200 used to aid in control of various features and functionality of the vehicle 1200, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1202 is described herein as being a CAN bus, this is not intended to be limiting. For example, in addition to, or alternatively from, the CAN bus, FlexRay and/or Ethernet may be used. Additionally, although a single line is used to represent the bus 1202, this is not intended to be limiting. For example, there may be any number of busses 1202, which may include one or more CAN busses, one or more FlexRay busses, one or more Ethernet busses, and/or one or more other types of busses using a different protocol. In some examples, two or more busses 1202 may be used to perform different functions, and/or may be used for redundancy. For example, a first bus 1202 may be used for collision avoidance functionality and a second bus 1202 may be used for actuation control. In any example, each bus 1202 may communicate with any of the components of the vehicle 1200, and two or more busses 1202 may communicate with the same components. In some examples, each SoC 1204, each controller 1236, and/or each computer within the vehicle may have access to the same input data (e.g., inputs from sensors of the vehicle 1200), and may be connected to a common bus, such the CAN bus.

The vehicle 1200 may include one or more controller(s) 1236, such as those described herein with respect to FIG. 12A. The controller(s) 1236 may be used for a variety of functions. The controller(s) 1236 may be coupled to any of the various other components and systems of the vehicle 1200, and may be used for control of the vehicle 1200, artificial intelligence of the vehicle 1200, infotainment for the vehicle 1200, and/or the like.

The vehicle 1200 may include a system(s) on a chip (SoC) 1204. The SoC 1204 may include CPU(s) 1206, GPU(s) 1208, processor(s) 1210, cache(s) 1212, accelerator(s) 1214, data store(s) 1216, and/or other components and features not illustrated. The SoC(s) 1204 may be used to control the vehicle 1200 in a variety of platforms and systems. For example, the SoC(s) 1204 may be combined in a system (e.g., the system of the vehicle 1200) with an HD map 1222 which may obtain map refreshes and/or updates via a network interface 1224 from one or more servers (e.g., server(s) 1278 of FIG. 12D).

The CPU(s) 1206 may include a CPU cluster or CPU complex (alternatively referred to herein as a “CCPLEX”). The CPU(s) 1206 may include multiple cores and/or L2 caches. For example, in some embodiments, the CPU(s) 1206 may include eight cores in a coherent multi-processor configuration. In some embodiments, the CPU(s) 1206 may include four dual-core clusters where each cluster has a dedicated L2 cache (e.g., a 2 MB L2 cache). The CPU(s) 1206 (e.g., the CCPLEX) may be configured to support simultaneous cluster operation allowing any combination of the clusters of the CPU(s) 1206 to be active at any given time.

The CPU(s) 1206 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1206 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1208 may include an integrated GPU (alternatively referred to herein as an “iGPU”). The GPU(s) 1208 may be programmable and may be efficient for parallel workloads. The GPU(s) 1208, in some examples, may use an enhanced tensor instruction set. The GPU(s) 1208 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1208 may include at least eight streaming microprocessors. The GPU(s) 1208 may use compute application programming interface(s) (API(s)). In addition, the GPU(s) 1208 may use one or more parallel computing platforms and/or programming models (e.g., NVIDIA's CUDA).

The GPU(s) 1208 may be power-optimized for best performance in automotive and embedded use cases. For example, the GPU(s) 1208 may be fabricated on a Fin field-effect transistor (FinFET). However, this is not intended to be limiting and the GPU(s) 1208 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to allow finer-grain synchronization and cooperation between parallel threads. The streaming microprocessors may include a combined L1 data cache and shared memory unit in order to improve performance while simplifying programming.

The GPU(s) 1208 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1208 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1208 to access the CPU(s) 1206 page tables directly. In such examples, when the GPU(s) 1208 memory management unit (MMU) experiences a miss, an address translation request may be transmitted to the CPU(s) 1206. In response, the CPU(s) 1206 may look in its page tables for the virtual-to-physical mapping for the address and transmits the translation back to the GPU(s) 1208. As such, unified memory technology may allow a single unified virtual address space for memory of both the CPU(s) 1206 and the GPU(s) 1208, thereby simplifying the GPU(s) 1208 programming and porting of applications to the GPU(s) 1208.

In addition, the GPU(s) 1208 may include an access counter that may keep track of the frequency of access of the GPU(s) 1208 to memory of other processors. The access counter may help ensure that memory pages are moved to the physical memory of the processor that is accessing the pages most frequently.

The SoC(s) 1204 may include any number of cache(s) 1212, including those described herein. For example, the cache(s) 1212 may include an L3 cache that is available to both the CPU(s) 1206 and the GPU(s) 1208 (e.g., that is connected both the CPU(s) 1206 and the GPU(s) 1208). The cache(s) 1212 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1204 may include an arithmetic logic unit(s) (ALU(s)) which may be leveraged in performing processing with respect to any of the variety of tasks or operations of the vehicle 1200—such as processing DNNs. In addition, the SoC(s) 1204 may include a floating point unit(s) (FPU(s))—or other math coprocessor or numeric coprocessor types—for performing mathematical operations within the system. For example, the SoC(s) 1204 may include one or more FPUs integrated as execution units within a CPU(s) 1206 and/or GPU(s) 1208.

The SoC(s) 1204 may include one or more accelerators 1214 (e.g., hardware accelerators, software accelerators, or a combination thereof). For example, the SoC(s) 1204 may include a hardware acceleration cluster that may include optimized hardware accelerators and/or large on-chip memory. The large on-chip memory (e.g., 4 MB of SRAM), may allow the hardware acceleration cluster to accelerate neural networks and other calculations. The hardware acceleration cluster may be used to complement the GPU(s) 1208 and to off-load some of the tasks of the GPU(s) 1208 (e.g., to free up more cycles of the GPU(s) 1208 for performing other tasks). As an example, the accelerator(s) 1214 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1214 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1208, and by using an inference accelerator, for example, a designer may target either the DLA(s) or the GPU(s) 1208 for any function. For example, the designer may focus processing of CNNs and floating point operations on the DLA(s) and leave other functions to the GPU(s) 1208 and/or other accelerator(s) 1214.

The accelerator(s) 1214 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may allow components of the PVA(s) to access the system memory independently of the CPU(s) 1206. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1214 (e.g., the hardware acceleration cluster) may include a computer vision network on-chip and SRAM, for providing a high-bandwidth, low latency SRAM for the accelerator(s) 1214. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1204 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 1214 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. As such, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1266 output that correlates with the vehicle 1200 orientation, distance, 3D location estimates of the object obtained from the neural network and/or other sensors (e.g., LiDAR sensor(s) 1264 or RADAR sensor(s) 1260), among others.

The SoC(s) 1204 may include data store(s) 1216 (e.g., memory). The data store(s) 1216 may be on-chip memory of the SoC(s) 1204, which may store neural networks to be executed on the GPU and/or the DLA. In some examples, the data store(s) 1216 may be large enough in capacity to store multiple instances of neural networks for redundancy and safety. The data store(s) 1216 may comprise L2 or L3 cache(s) 1212. Reference to the data store(s) 1216 may include reference to the memory associated with the PVA, DLA, and/or other accelerator(s) 1214, as described herein.

The SoC(s) 1204 may include one or more processor(s) 1210 (e.g., embedded processors). The processor(s) 1210 may include a boot and power management processor that may be a dedicated processor and subsystem to handle boot power and management functions and related security enforcement. The boot and power management processor may be a part of the SoC(s) 1204 boot sequence and may provide runtime power management services. The boot power and management processor may provide clock and voltage programming, assistance in system low power state transitions, management of SoC(s) 1204 thermals and temperature sensors, and/or management of the SoC(s) 1204 power states. Each temperature sensor may be implemented as a ring-oscillator whose output frequency is proportional to temperature, and the SoC(s) 1204 may use the ring-oscillators to detect temperatures of the CPU(s) 1206, GPU(s) 1208, and/or accelerator(s) 1214. If temperatures are determined to exceed a threshold, the boot and power management processor may enter a temperature fault routine and put the SoC(s) 1204 into a lower power state and/or put the vehicle 1200 into a chauffeur to safe stop mode (e.g., bring the vehicle 1200 to a safe stop).

The processor(s) 1210 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1210 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1210 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1210 may further include a real-time camera engine that may include a dedicated processor subsystem for handling real-time camera management.

The processor(s) 1210 may further include a high-dynamic range signal processor that may include an image signal processor that is a hardware engine that is part of the camera processing pipeline.

The processor(s) 1210 may include a video image compositor that may be a processing block (e.g., implemented on a microprocessor) that implements video post-processing functions needed by a video playback application to produce the final image for the player window. The video image compositor may perform lens distortion correction on wide-view camera(s) 1270, surround camera(s) 1274, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1208 is not required to continuously render new surfaces. Even when the GPU(s) 1208 is powered on and active doing 3D rendering, the video image compositor may be used to offload the GPU(s) 1208 to improve performance and responsiveness.

The SoC(s) 1204 may further include a mobile industry processor interface (MIPI) camera serial interface for receiving video and input from cameras, a high-speed interface, and/or a video input block that may be used for camera and related pixel input functions. The SoC(s) 1204 may further include an input/output controller(s) that may be controlled by software and may be used for receiving I/O signals that are uncommitted to a specific role.

The SoC(s) 1204 may further include a broad range of peripheral interfaces to allow communication with peripherals, audio codecs, power management, and/or other devices. The SoC(s) 1204 may be used to process data from cameras (e.g., connected over Gigabit Multimedia Serial Link and Ethernet), sensors (e.g., LiDAR sensor(s) 1264, RADAR sensor(s) 1260, etc. that may be connected over Ethernet), data from bus 1202 (e.g., speed of vehicle 1200, steering wheel position, etc.), data from GNSS sensor(s) 1258 (e.g., connected over Ethernet or CAN bus). The SoC(s) 1204 may further include dedicated high-performance mass storage controllers that may include their own DMA engines, and that may be used to free the CPU(s) 1206 from routine data management tasks.

The SoC(s) 1204 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1204 may be faster, more reliable, and even more energy-efficient and space-efficient than conventional systems. For example, the accelerator(s) 1214, when combined with the CPU(s) 1206, the GPU(s) 1208, and the data store(s) 1216, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to allow Level 3-5 autonomous driving functionality. For example, a CNN executing on the DLA or dGPU (e.g., the GPU(s) 1220) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1208.

In some examples, a CNN for facial recognition and vehicle owner identification may use data from camera sensors to identify the presence of an authorized driver and/or owner of the vehicle 1200. The always on sensor processing engine may be used to unlock the vehicle when the owner approaches the driver door and turn on the lights, and, in security mode, to disable the vehicle when the owner leaves the vehicle. In this way, the SoC(s) 1204 provide for security against theft and/or carjacking.

In another example, a CNN for emergency vehicle detection and identification may use data from microphones 1296 to detect and identify emergency vehicle sirens. In contrast to conventional systems, that use general classifiers to detect sirens and manually extract features, the SoC(s) 1204 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1258. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1262, until the emergency vehicle(s) passes.

The vehicle may include a CPU(s) 1218 (e.g., discrete CPU(s), or dCPU(s)), that may be coupled to the SoC(s) 1204 via a high-speed interconnect (e.g., PCIe). The CPU(s) 1218 may include an X86 processor, for example. The CPU(s) 1218 may be used to perform any of a variety of functions, including arbitrating potentially inconsistent results between ADAS sensors and the SoC(s) 1204, and/or monitoring the status and health of the controller(s) 1236 and/or infotainment SoC 1230, for example.

The vehicle 1200 may include a GPU(s) 1220 (e.g., discrete GPU(s), or dGPU(s)), that may be coupled to the SoC(s) 1204 via a high-speed interconnect (e.g., NVIDIA's NVLINK). The GPU(s) 1220 may provide additional artificial intelligence functionality, such as by executing redundant and/or different neural networks, and may be used to train and/or update neural networks based on input (e.g., sensor data) from sensors of the vehicle 1200.

The vehicle 1200 may further include the network interface 1224 which may include one or more wireless antennas 1226 (e.g., one or more wireless antennas for different communication protocols, such as a cellular antenna, a Bluetooth antenna, etc.). The network interface 1224 may be used to allow wireless connectivity over the Internet with the cloud (e.g., with the server(s) 1278 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1200 information about vehicles in proximity to the vehicle 1200 (e.g., vehicles in front of, on the side of, and/or behind the vehicle 1200). This functionality may be part of a cooperative adaptive cruise control functionality of the vehicle 1200.

The network interface 1224 may include a SoC that provides modulation and demodulation functionality and enables the controller(s) 1236 to communicate over wireless networks. The network interface 1224 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1200 may further include data store(s) 1228 which may include off-chip (e.g., off the SoC(s) 1204) storage. The data store(s) 1228 may include one or more storage elements including RAM, SRAM, DRAM, VRAM, Flash, hard disks, and/or other components and/or devices that may store at least one bit of data.

The vehicle 1200 may further include GNSS sensor(s) 1258. The GNSS sensor(s) 1258 (e.g., GPS, assisted GPS sensors, differential GPS (DGPS) sensors, etc.), to assist in mapping, perception, occupancy grid generation, and/or path planning functions. Any number of GNSS sensor(s) 1258 may be used, including, for example and without limitation, a GPS using a USB connector with an Ethernet to Serial (RS-232) bridge.

The vehicle 1200 may further include RADAR sensor(s) 1260. The RADAR sensor(s) 1260 may be used by the vehicle 1200 for long-range vehicle detection, even in darkness and/or severe weather conditions. RADAR functional safety levels may be ASIL B. The RADAR sensor(s) 1260 may use the CAN and/or the bus 1202 (e.g., to transmit data generated using the RADAR sensor(s) 1260) for control and to access object tracking data, with access to Ethernet to access raw data in some examples. A wide variety of RADAR sensor types may be used. For example, and without limitation, the RADAR sensor(s) 1260 may be suitable for front, rear, and side RADAR use. In some example, Pulse Doppler RADAR sensor(s) are used.

The RADAR sensor(s) 1260 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1260 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1200 surroundings at higher speeds with minimal interference from traffic in adjacent lanes. The other two antennae may expand the field of view, making it possible to quickly detect vehicles entering or leaving the vehicle's 1200 lane.

Mid-range RADAR systems may include, as an example, a range of up to 1260 m (front) or 80 m (rear), and a field of view of up to 42 degrees (front) or 1250 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1200 may further include ultrasonic sensor(s) 1262. The ultrasonic sensor(s) 1262, which may be positioned at the front, back, and/or the sides of the vehicle 1200, may be used for park assist and/or to create and update an occupancy grid. A wide variety of ultrasonic sensor(s) 1262 may be used, and different ultrasonic sensor(s) 1262 may be used for different ranges of detection (e.g., 2.5 m, 4 m). The ultrasonic sensor(s) 1262 may operate at functional safety levels of ASIL B.

The vehicle 1200 may include LiDAR sensor(s) 1264. The LiDAR sensor(s) 1264 may be used for object and pedestrian detection, emergency braking, collision avoidance, and/or other functions. The LiDAR sensor(s) 1264 may be functional safety level ASIL B. In some examples, the vehicle 1200 may include multiple LiDAR sensors 1264 (e.g., two, four, six, etc.) that may use Ethernet (e.g., to provide data to a Gigabit Ethernet switch).

In some examples, the LiDAR sensor(s) 1264 may be capable of providing a list of objects and their distances for a 360-degree field of view. Commercially available LiDAR sensor(s) 1264 may have an advertised range of approximately 1200 m, with an accuracy of 2 cm-3 cm, and with support for a 1200 Mbps Ethernet connection, for example. In some examples, one or more non-protruding LiDAR sensors 1264 may be used. In such examples, the LiDAR sensor(s) 1264 may be implemented as a small device that may be embedded into the front, rear, sides, and/or corners of the vehicle 1200. The LiDAR sensor(s) 1264, in such examples, may provide up to a 120-degree horizontal and 35-degree vertical field-of-view, with a 200 m range even for low-reflectivity objects. Front-mounted LiDAR sensor(s) 1264 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 1200. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 1264 may be less susceptible to motion blur, vibration, and/or shock.

The vehicle may further include IMU sensor(s) 1266. The IMU sensor(s) 1266 may be located at a center of the rear axle of the vehicle 1200, in some examples. The IMU sensor(s) 1266 may include, for example and without limitation, an accelerometer(s), a magnetometer(s), a gyroscope(s), a magnetic compass(es), and/or other sensor types. In some examples, such as in six-axis applications, the IMU sensor(s) 1266 may include accelerometers and gyroscopes, while in nine-axis applications, the IMU sensor(s) 1266 may include accelerometers, gyroscopes, and magnetometers.

In some embodiments, the IMU sensor(s) 1266 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1266 may allow the vehicle 1200 to estimate heading without requiring input from a magnetic sensor by directly observing and correlating the changes in velocity from GPS to the IMU sensor(s) 1266. In some examples, the IMU sensor(s) 1266 and the GNSS sensor(s) 1258 may be combined in a single integrated unit.

The vehicle may include microphone(s) 1296 placed in and/or around the vehicle 1200. The microphone(s) 1296 may be used for emergency vehicle detection and identification, among other things.

The vehicle may further include any number of camera types, including stereo camera(s) 1268, wide-view camera(s) 1270, infrared camera(s) 1272, surround camera(s) 1274, long-range and/or mid-range camera(s) 1298, and/or other camera types. The cameras may be used to capture image data around an entire periphery of the vehicle 1200. The types of cameras used depends on the embodiments and requirements for the vehicle 1200, and any combination of camera types may be used to provide the necessary coverage around the vehicle 1200. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 12A and FIG. 12B.

The vehicle 1200 may further include vibration sensor(s) 1242. The vibration sensor(s) 1242 may measure vibrations of components of the vehicle, such as the axle(s). For example, changes in vibrations may indicate a change in road surfaces. In another example, when two or more vibration sensors 1242 are used, the differences between the vibrations may be used to determine friction or slippage of the road surface (e.g., when the difference in vibration is between a power-driven axle and a freely rotating axle).

The vehicle 1200 may include an ADAS system 1238. The ADAS system 1238 may include a SoC, in some examples. The ADAS system 1238 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1260, LiDAR sensor(s) 1264, and/or a camera(s). The ACC systems may include longitudinal ACC and/or lateral ACC. Longitudinal ACC monitors and controls the distance to the vehicle immediately ahead of the vehicle 1200 and automatically adjust the vehicle speed to maintain a safe distance from vehicles ahead. Lateral ACC performs distance keeping, and advises the vehicle 1200 to change lanes when necessary. Lateral ACC is related to other ADAS applications such as LCA and CWS.

CACC uses information from other vehicles that may be received via the network interface 1224 and/or the wireless antenna(s) 1226 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1200), while the I2V communication concept provides information about traffic further ahead. CACC systems may include either or both I2V and V2V information sources. Given the information of the vehicles ahead of the vehicle 1200, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1260, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1260, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1200 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1200 if the vehicle 1200 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1260, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1200 is backing up. Some RCTW systems include AEB to ensure that the vehicle brakes are applied to avoid a crash. RCTW systems may use one or more rear-facing RADAR sensor(s) 1260, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1200, the vehicle 1200 itself must, in the case of conflicting results, decide whether to heed the result from a primary computer or a secondary computer (e.g., a first controller 1236 or a second controller 1236). For example, in some embodiments, the ADAS system 1238 may be a backup and/or secondary computer for providing perception information to a backup computer rationality module. The backup computer rationality monitor may run a redundant diverse software on hardware components to detect faults in perception and dynamic driving tasks. Outputs from the ADAS system 1238 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1204.

In other examples, ADAS system 1238 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1238 may be fed into the primary computer's perception block and/or the primary computer's dynamic driving task block. For example, if the ADAS system 1238 indicates a forward crash warning due to an object immediately ahead, the perception block may use this information when identifying objects. In other examples, the secondary computer may have its own neural network which is trained and thus reduces the risk of false positives, as described herein.

The vehicle 1200 may further include the infotainment SoC 1230 (e.g., an in-vehicle infotainment system (IVI)). Although illustrated and described as a SoC, the infotainment system may not be a SoC, and may include two or more discrete components. The infotainment SoC 1230 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1200. For example, the infotainment SoC 1230 may radios, disk players, navigation systems, video players, USB and Bluetooth connectivity, carputers, in-car entertainment, Wi-Fi, steering wheel audio controls, hands free voice control, a heads-up display (HUD), an HMI display 1234, a telematics device, a control panel (e.g., for controlling and/or interacting with various components, features, and/or systems), and/or other components. The infotainment SoC 1230 may further be used to provide information (e.g., visual and/or audible) to a user(s) of the vehicle, such as information from the ADAS system 1238, autonomous driving information such as planned vehicle maneuvers, trajectories, surrounding environment information (e.g., intersection information, vehicle information, road information, etc.), and/or other information.

The infotainment SoC 1230 may include GPU functionality. The infotainment SoC 1230 may communicate over the bus 1202 (e.g., CAN bus, Ethernet, etc.) with other devices, systems, and/or components of the vehicle 1200. In some examples, the infotainment SoC 1230 may be coupled to a supervisory MCU such that the GPU of the infotainment system may perform some self-driving functions in the event that the primary controller(s) 1236 (e.g., the primary and/or backup computers of the vehicle 1200) fail. In such an example, the infotainment SoC 1230 may put the vehicle 1200 into a chauffeur to safe stop mode, as described herein.

The vehicle 1200 may further include an instrument cluster 1232 (e.g., a digital dash, an electronic instrument cluster, a digital instrument panel, etc.). The instrument cluster 1232 may include a controller and/or supercomputer (e.g., a discrete controller or supercomputer). The instrument cluster 1232 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1230 and the instrument cluster 1232. As such, the instrument cluster 1232 may be included as part of the infotainment SoC 1230, or vice versa.

FIG. 12D is a system diagram for communication between cloud-based server(s) and the example autonomous vehicle 1200 of FIG. 12A, in accordance with some embodiments of the present disclosure. The system 1276 may include server(s) 1278, network(s) 1290, and vehicles, including the vehicle 1200. The server(s) 1278 may include a plurality of GPUs 1284(A)-1284(H) (collectively referred to herein as GPUs 1284), PCIe switches 1282(A)-1282(D) (collectively referred to herein as PCIe switches 1282), and/or CPUs 1280(A)-1280(B) (collectively referred to herein as CPUs 1280). The GPUs 1284, the CPUs 1280, and the PCIe switches may be interconnected with high-speed interconnects such as, for example and without limitation, NVLink interfaces 1288 developed by NVIDIA and/or PCIe connections 1286. In some examples, the GPUs 1284 are connected via NVLink and/or NVSwitch SoC and the GPUs 1284 and the PCIe switches 1282 are connected via PCIe interconnects. Although eight GPUs 1284, two CPUs 1280, and two PCIe switches are illustrated, this is not intended to be limiting. Depending on the embodiment, each of the server(s) 1278 may include any number of GPUs 1284, CPUs 1280, and/or PCIe switches. For example, the server(s) 1278 may each include eight, sixteen, thirty-two, and/or more GPUs 1284.

The server(s) 1278 may receive, over the network(s) 1290 and from the vehicles, image data representative of images showing unexpected or changed road conditions, such as recently commenced road-work. The server(s) 1278 may transmit, over the network(s) 1290 and to the vehicles, neural networks 1292, updated neural networks 1292, and/or map information 1294, including information regarding traffic and road conditions. The updates to the map information 1294 may include updates for the HD map 1222, such as information regarding construction sites, potholes, detours, flooding, and/or other obstructions. In some examples, the neural networks 1292, the updated neural networks 1292, and/or the map information 1294 may have resulted from new training and/or experiences represented in data received from any number of vehicles in the environment, and/or based on training performed at a datacenter (e.g., using the server(s) 1278 and/or other servers).

The server(s) 1278 may be used to train machine learning models (e.g., neural networks) based on training data. The training data may be generated using the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1290, and/or the machine learning models may be used by the server(s) 1278 to remotely monitor the vehicles.

In some examples, the server(s) 1278 may receive data from the vehicles and apply the data to up-to-date real-time neural networks for real-time intelligent inferencing. The server(s) 1278 may include deep-learning supercomputers and/or dedicated AI computers powered by GPU(s) 1284, such as a DGX and DGX Station machines developed by NVIDIA. However, in some examples, the server(s) 1278 may include deep learning infrastructure that use only CPU-powered datacenters.

The deep-learning infrastructure of the server(s) 1278 may be capable of fast, real-time inferencing, and may use that capability to evaluate and verify the health of the processors, software, and/or associated hardware in the vehicle 1200. For example, the deep-learning infrastructure may receive periodic updates from the vehicle 1200, such as a sequence of images and/or objects that the vehicle 1200 has located in that sequence of images (e.g., via computer vision and/or other machine learning object classification techniques). The deep-learning infrastructure may run its own neural network to identify the objects and compare them with the objects identified by the vehicle 1200 and, if the results do not match and the infrastructure concludes that the AI in the vehicle 1200 is malfunctioning, the server(s) 1278 may transmit a signal to the vehicle 1200 instructing a fail-safe computer of the vehicle 1200 to assume control, notify the passengers, and complete a safe parking maneuver.

For inferencing, the server(s) 1278 may include the GPU(s) 1284 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 13 is a block diagram of an example computing device(s) 1300 suitable for use in implementing some embodiments of the present disclosure. Computing device 1300 may include an interconnect system 1302 that directly or indirectly couples the following devices: memory 1304, one or more central processing units (CPUs) 1306, one or more graphics processing units (GPUs) 1308, a communication interface 1310, input/output (I/O) ports 1312, input/output components 1314, a power supply 1316, one or more presentation components 1318 (e.g., display(s)), and one or more logic units 1320. In at least one embodiment, the computing device(s) 1300 may comprise one or more virtual machines (VMs), and/or any of the components thereof may comprise virtual components (e.g., virtual hardware components). For non-limiting examples, one or more of the GPUs 1308 may comprise one or more vGPUs, one or more of the CPUs 1306 may comprise one or more vCPUs, and/or one or more of the logic units 1320 may comprise one or more virtual logic units. As such, a computing device(s) 1300 may include discrete components (e.g., a full GPU dedicated to the computing device 1300), virtual components (e.g., a portion of a GPU dedicated to the computing device 1300), or a combination thereof.

Although the various blocks of FIG. 13 are shown as connected via the interconnect system 1302 with lines, this is not intended to be limiting and is for clarity only. For example, in some embodiments, a presentation component 1318, such as a display device, may be considered an I/O component 1314 (e.g., if the display is a touch screen). As another example, the CPUs 1306 and/or GPUs 1308 may include memory (e.g., the memory 1304 may be representative of a storage device in addition to the memory of the GPUs 1308, the CPUs 1306, and/or other components). As such, the computing device of FIG. 13 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 13.

The interconnect system 1302 may represent one or more links or busses, such as an address bus, a data bus, a control bus, or a combination thereof. The interconnect system 1302 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1306 may be directly connected to the memory 1304. Further, the CPU 1306 may be directly connected to the GPU 1308. Where there is direct, or point-to-point connection between components, the interconnect system 1302 may include a PCIe link to carry out the connection. In these examples, a PCI bus need not be included in the computing device 1300.

The memory 1304 may include any of a variety of computer-readable media. The computer-readable media may be any available media that may be accessed by the computing device 1300. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1304 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1300. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1306 may be configured to execute at least some of the computer-readable instructions to control one or more components of the computing device 1300 to perform one or more of the methods and/or processes described herein. The CPU(s) 1306 may each include one or more cores (e.g., one, two, four, eight, twenty-eight, seventy-two, etc.) that are capable of handling a multitude of software threads simultaneously. The CPU(s) 1306 may include any type of processor, and may include different types of processors depending on the type of computing device 1300 implemented (e.g., processors with fewer cores for mobile devices and processors with more cores for servers). For example, depending on the type of computing device 1300, the processor may be an Advanced RISC Machines (ARM) processor implemented using Reduced Instruction Set Computing (RISC) or an x86 processor implemented using Complex Instruction Set Computing (CISC). The computing device 1300 may include one or more CPUs 1306 in addition to one or more microprocessors or supplementary co-processors, such as math co-processors.

In addition to or alternatively from the CPU(s) 1306, the GPU(s) 1308 may be configured to execute at least some of the computer-readable instructions to control one or more components of the computing device 1300 to perform one or more of the methods and/or processes described herein. One or more of the GPU(s) 1308 may be an integrated GPU (e.g., with one or more of the CPU(s) 1306 and/or one or more of the GPU(s) 1308 may be a discrete GPU. In embodiments, one or more of the GPU(s) 1308 may be a coprocessor of one or more of the CPU(s) 1306. The GPU(s) 1308 may be used by the computing device 1300 to render graphics (e.g., 3D graphics) or perform general purpose computations. For example, the GPU(s) 1308 may be used for General-Purpose computing on GPUs (GPGPU). The GPU(s) 1308 may include hundreds or thousands of cores that are capable of handling hundreds or thousands of software threads simultaneously. The GPU(s) 1308 may generate pixel data for output images in response to rendering commands (e.g., rendering commands from the CPU(s) 1306 received via a host interface). The GPU(s) 1308 may include graphics memory, such as display memory, for storing pixel data or any other suitable data, such as GPGPU data. The display memory may be included as part of the memory 1304. The GPU(s) 1308 may include two or more GPUs operating in parallel (e.g., via a link). The link may directly connect the GPUs (e.g., using NVLINK) or may connect the GPUs through a switch (e.g., using NVSwitch). When combined together, each GPU 1308 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1306 and/or the GPU(s) 1308, the logic unit(s) 1320 may be configured to execute at least some of the computer-readable instructions to control one or more components of the computing device 1300 to perform one or more of the methods and/or processes described herein. In embodiments, the CPU(s) 1306, the GPU(s) 1308, and/or the logic unit(s) 1320 may discretely or jointly perform any combination of the methods, processes and/or portions thereof. One or more of the logic units 1320 may be part of and/or integrated in one or more of the CPU(s) 1306 and/or the GPU(s) 1308 and/or one or more of the logic units 1320 may be discrete components or otherwise external to the CPU(s) 1306 and/or the GPU(s) 1308. In embodiments, one or more of the logic units 1320 may be a coprocessor of one or more of the CPU(s) 1306 and/or one or more of the GPU(s) 1308.

Examples of the logic unit(s) 1320 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1310 may include one or more receivers, transmitters, and/or transceivers that allow the computing device 1300 to communicate with other computing devices via an electronic communication network, included wired and/or wireless communications. The communication interface 1310 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1320 and/or communication interface 1310 may include one or more data processing units (DPUs) to transmit data received over a network and/or through interconnect system 1302 directly to (e.g., a memory of) one or more GPU(s) 1308.

The I/O ports 1312 may allow the computing device 1300 to be logically coupled to other devices including the I/O components 1314, the presentation component(s) 1318, and/or other components, some of which may be built in to (e.g., integrated in) the computing device 1300. Illustrative I/O components 1314 include a microphone, mouse, keyboard, joystick, game pad, game controller, satellite dish, scanner, printer, wireless device, etc. The I/O components 1314 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1300. The computing device 1300 may be include depth cameras, such as stereoscopic camera systems, infrared camera systems, RGB camera systems, touchscreen technology, and combinations of these, for gesture detection and recognition. Additionally, the computing device 1300 may include accelerometers or gyroscopes (e.g., as part of an inertia measurement unit (IMU)) that allow detection of motion. In some examples, the output of the accelerometers or gyroscopes may be used by the computing device 1300 to render immersive augmented reality or virtual reality.

The power supply 1316 may include a hard-wired power supply, a battery power supply, or a combination thereof. The power supply 1316 may provide power to the computing device 1300 to allow the components of the computing device 1300 to operate.

The presentation component(s) 1318 may include a display (e.g., a monitor, a touch screen, a television screen, a heads-up-display (HUD), other display types, or a combination thereof), speakers, and/or other presentation components. The presentation component(s) 1318 may receive data from other components (e.g., the GPU(s) 1308, the CPU(s) 1306, DPUs, etc.), and output the data (e.g., as an image, video, sound, etc.).

EXAMPLE DATA CENTER

FIG. 14 illustrates an example data center 1400 that may be used in at least one embodiments of the present disclosure. The data center 1400 may include a data center infrastructure layer 1410, a framework layer 1420, a software layer 1430, and/or an application layer 1440.

As shown in FIG. 14, the data center infrastructure layer 1410 may include a resource orchestrator 1412, grouped computing resources 1414, and node computing resources (“node C.R.s”) 1416(1)-1416(N), where “N” represents any whole, positive integer. In at least one embodiment, node C.R.s 1416(1)-1416(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1416(1)-1416(N) may correspond to a server having one or more of the above-mentioned computing resources. In addition, in some embodiments, the node C.R.s 1416(1)-14161(N) may include one or more virtual components, such as vGPUs, vCPUs, and/or the like, and/or one or more of the node C.R.s 1416(1)-1416(N) may correspond to a virtual machine (VM).

In at least one embodiment, grouped computing resources 1414 may include separate groupings of node C.R.s 1416 housed within one or more racks (not shown), or many racks housed in data centers at various geographical locations (also not shown). Separate groupings of node C.R.s 1416 within grouped computing resources 1414 may include grouped compute, network, memory or storage resources that may be configured or allocated to support one or more workloads. In at least one embodiment, several node C.R.s 1416 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1412 may configure or otherwise control one or more node C.R.s 1416(1)-1416(N) and/or grouped computing resources 1414. In at least one embodiment, resource orchestrator 1412 may include a software design infrastructure (SDI) management entity for the data center 1400. The resource orchestrator 1412 may include hardware, software, or some combination thereof.

In at least one embodiment, as shown in FIG. 14, framework layer 1420 may include a job scheduler 1433, a configuration manager 1434, a resource manager 1436, and/or a distributed file system 1438. The framework layer 1420 may include a framework to support software 1432 of software layer 1430 and/or one or more application(s) 1442 of application layer 1440. The software 1432 or application(s) 1442 may respectively include web-based service software or applications, such as those provided by Amazon Web Services, Google Cloud and Microsoft Azure. The framework layer 1420 may be, but is not limited to, a type of free and open-source software web application framework such as Apache Spark™ (hereinafter “Spark”) that may use distributed file system 1438 for large-scale data processing (e.g., “big data”). In at least one embodiment, job scheduler 1433 may include a Spark driver to facilitate scheduling of workloads supported by various layers of data center 1400. The configuration manager 1434 may be capable of configuring different layers such as software layer 1430 and framework layer 1420 including Spark and distributed file system 1438 for supporting large-scale data processing. The resource manager 1436 may be capable of managing clustered or grouped computing resources mapped to or allocated for support of distributed file system 1438 and job scheduler 1433. In at least one embodiment, clustered or grouped computing resources may include grouped computing resource 1414 at data center infrastructure layer 1410. The resource manager 1436 may coordinate with resource orchestrator 1412 to manage these mapped or allocated computing resources.

In at least one embodiment, software 1432 included in software layer 1430 may include software used by at least portions of node C.R.s 1416(1)-1416(N), grouped computing resources 1414, and/or distributed file system 1438 of framework layer 1420. One or more types of software may include, but are not limited to, Internet web page search software, e-mail virus scan software, database software, and streaming video content software.

In at least one embodiment, application(s) 1442 included in application layer 1440 may include one or more types of applications used by at least portions of node C.R.s 1416(1)-1416(N), grouped computing resources 1414, and/or distributed file system 1438 of framework layer 1420. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1434, resource manager 1436, and resource orchestrator 1412 may implement any number and type of self-modifying actions based on any amount and type of data acquired in any technically feasible fashion. Self-modifying actions may relieve a data center operator of data center 1400 from making possibly bad configuration decisions and possibly avoiding underutilized and/or poor performing portions of a data center.

The data center 1400 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1400. In at least one embodiment, trained or deployed machine learning models corresponding to one or more neural networks may be used to infer or predict information using resources described above with respect to the data center 1400 by using weight parameters calculated through one or more training techniques, such as but not limited to those described herein.

In at least one embodiment, the data center 1400 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1300 of FIG. 13—e.g., each device may include similar components, features, and/or functionality of the computing device(s) 1300. In addition, where backend devices (e.g., servers, NAS, etc.) are implemented, the backend devices may be included as part of a data center 1400, an example of which is described in more detail herein with respect to FIG. 14.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1300 described herein with respect to FIG. 13. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Literal Support

In an example embodiment, one or more processors comprise one or more processing units to: receive at least one of, one or more material maps or one or more lighting maps, the one or more material maps defining one or more properties of a surface of one or more objects in a scene, the one or more lighting maps representing at least one of one or more shading or lighting characteristics associated with the one or more objects; and provide a first noise vector and a representation of at least one of the one or more material maps or the or more lighting maps as input into one or more first machine learning models to generate an output frame of the scene, the first noise vector corresponding to an initial starting point for a diffusion process performed by the one or more first machine learning models.

In some embodiments, the one or more material maps include at least one of: an albedo map, a normal map, a roughness map, a metallic map, an ambient occlusion map, a displacement map, a specular map, an emissive map, an opacity map, a cavity map, or a subsurface scattering map.

In some embodiments, the one or more processing units are further to: receive user input requesting at least one of a material property or a lighting condition to be incorporated into the output frame; and based at least in part on the user input, generate at least one of the one or more material maps or the one or more lighting maps, and wherein the output frame is generated based at least in part on the user input.

In some embodiments, the one or more processing units are further to: receive an input frame and a second noise vector; and provide the second noise vector and a representation of the input frame and as input into one or more second machine learning models to generate the one or more first material maps.

In some embodiments, the one or more processing units are further to: provide an input frame as input into the one or more first machine learning models, and wherein the first noise vector represents a noisy version of the input frame; and receive a request to enhance the input frame, wherein the output frame is generated based at least in part on the request and of the one or more processing units are to provide the input frame as input into the one or more first machine learning models, and wherein the output frame includes one or more features that have been enhanced relative to the input frame.

In some embodiments, the one or more processing units are further to: provide a two-dimensional input frame and a second noise vector as input into one or more second machine learning models; and based at least on providing the two-dimensional input frame and the second noise vector as input into the one or more second machine learning models, generate the one or more material maps, wherein the output frame represents the two-dimensional input frame that includes a lighting property which has been modified in the output frame relative to the input frame.

In some embodiments, the one or more processing units are further to: provide a two-dimensional input frame and a second noise vector as input to one or more second machine learning models; and based at least in part on the input frame and the second noise vector being provided as input into the one or more second machine learning models, generate one or more second material maps.

In some embodiments, the one or more processing units are further to: generate a multidimensional frame based on the one or more second material maps, the multidimensional frame representing the two-dimensional input frame that includes at least one more dimension relative to the two-dimensional input frame; and generate the one or more first material maps based at least in part generating the multidimensional frame, and wherein the output frame is generated based at least in part on the multidimensional frame.

In some embodiments, the one or more processors is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using AI; a system for performing one or more operations using one or more large language models (LLMs); a system for performing one or more operations using one or more vision language models (VLMs); a system incorporating one or more virtual machines (VMs); a system implemented at least partially in a data center; or a system implemented at least partially using cloud computing resources.

In an embodiments, a system comprises one or more processing units to: receive an input frame; and provide a first noise vector and a representation of the input frame as input into one or more first machine learning models to generate one or more first material maps, the first noise vector corresponding to an initial starting point for a diffusion process performed by the one or more first machine learning models, the one or more first material maps defining one or more properties of a surface of one or more objects in a scene.

In some embodiments, the one or more first material maps include at least one of: an albedo map, a normal map, a roughness map, a metallic map, or an ambient occlusion map, a displacement map, a specular map, an emissive map, an opacity map, a cavity map, or a subsurface scattering map.

In some embodiments, the one or more processing units are further to: receive user input requesting at least one of a material property or a lighting condition to be incorporated into an output frame; and based at least in part on the user input, generate at least one of the one or more first material maps or the output frame.

In some embodiments, the one or more processing units are further to: receive one or more lighting maps that represent at least one of one or more shading or lighting characteristics associated with the one or more objects; and provide a representation of the or more lighting maps as input into one or more first machine learning models to generate an output frame based at least in part on the first noise vector, the one or more material maps, and the one or more lighting maps.

In some embodiments, the first noise vector represents a noisy version of the input frame, and wherein the one or more processing units are further to: receive a request to enhance the input frame, wherein an output frame is generated using the one or more first machine learning models based at least in part on the request and the input frame, and wherein the output frame includes one or more features that have been enhanced relative to the input frame.

In some embodiments, the input image represents a two-dimensional input frame, and wherein the one or more processing units are further to: provide the one or more first material maps, a user-specified lighting condition, and a second noise vector as input into one or more second machine learning models; and generate an output frame based at least in part the one or more first material maps, the user-specified lighting condition, and the second noise vector as input into the one or more second machine learning models, wherein the output frame represents the two-dimensional input frame that includes a lighting property that has been modified in the output frame relative to the input frame.

In some embodiments, the input frame represents a two-dimensional input frame, and wherein the one or more processing units are further to: generate a multidimensional frame based on the one or more first material maps, the multidimensional frame representing the two-dimensional input frame that includes at least one more dimension relative to the two-dimensional input frame; and based at least on the multidimensional frame, generate one or more second material maps.

In some embodiments, the one or more processing units are further to: provide a second noise vector and the one or more second material maps as input into one or more second machine learning models to generate an output frame, and wherein the output frame is generated based at least in part on generating the multidimensional frame.

In some embodiments, the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using AI; a system for performing one or more operations using one or more large language models (LLMs); a system for performing one or more operations using one or more vision language models (VLMs); a system incorporating one or more virtual machines (VMs); a system implemented at least partially in a data center; or a system implemented at least partially using cloud computing resources.

In an embodiments, a method comprises receiving at least one of: one or more first material maps, one or more first lighting maps, or an input frame; providing a representation of at least one of: a noise vector, the one or more first material maps, the or more first lighting maps, or the input frame as input into one or more first machine learning models; and generating an output based at least on one of the noise vector, the one or more first material maps, the one or more first lighting maps, or the input image, the output including at least one of an output frame, one or more second material maps, or one or more second lighting maps.

In some embodiments, the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using AI; a system for performing one or more operations using one or more large language models (LLMs); a system for performing one or more operations using one or more vision language models (VLMs); a system incorporating one or more virtual machines (VMs); a system implemented at least partially in a data center; or a system implemented at least partially using cloud computing resources.

What is claimed is:

1. One or more processors comprising:
one or more processing units to:
receive at least one of, one or more material maps or one or more lighting maps, the one or more material maps defining one or more properties of a surface of one or more objects in a scene, the one or more lighting maps representing at least one of one or more shading or lighting characteristics associated with the one or more objects; and
provide a first noise vector and a representation of at least one of the one or more material maps or the or more lighting maps as input into one or more first machine learning models to generate an output frame of the scene, the first noise vector corresponding to an initial starting point for a diffusion process performed by the one or more first machine learning models.

2. The one or more processors of claim 1, wherein the one or more material maps include at least one of: an albedo map, a normal map, a roughness map, a metallic map, an ambient occlusion map, a displacement map, a specular map, an emissive map, an opacity map, a cavity map, or a subsurface scattering map.

3. The one or more processors of claim 1, wherein one or more processing units are further to:
receive user input requesting at least one of a material property or a lighting condition to be incorporated into the output frame; and
based at least in part on the user input, generate at least one of the one or more material maps or the one or more lighting maps, and wherein the output frame is generated based at least in part on the user input.

4. The one or more processors of claim 1, wherein the one or more processing units are further to:
receive an input frame and a second noise vector; and
provide the second noise vector and a representation of the input frame and as input into one or more second machine learning models to generate the one or more first material maps.

5. The one or more processors of claim 1, wherein the one or more processing units are further to:
provide an input frame as input into the one or more first machine learning models, and wherein the first noise vector represents a noisy version of the input frame; and
receive a request to enhance the input frame, wherein the output frame is generated based at least in part on the request and the one or more processing units are further to provide the input frame as input into the one or more first machine learning models, and wherein the output frame includes one or more features that have been enhanced relative to the input frame.

6. The one or more processors of claim 1, wherein the one or more processing units are further to:
provide a two-dimensional input frame and a second noise vector as input into one or more second machine learning models; and
based at least on providing the two-dimensional input frame and the second noise vector as input into the one or more second machine learning models, generate the one or more material maps, wherein the output frame represents the two-dimensional input frame that includes a lighting property which has been modified in the output frame relative to the input frame.

7. The one or more processors of claim 1, wherein the one or more processing units are further to:
provide a two-dimensional input frame and a second noise vector as input to one or more second machine learning models; and
based at least in part on the input frame and the second noise vector being provided as input into the one or more second machine learning models, generate one or more second material maps.

8. The one or more processors of claim 7, wherein the one or more processing units are further to:
generate a multidimensional frame based on the one or more second material maps, the multidimensional frame representing the two-dimensional input frame that includes at least one more dimension relative to the two-dimensional input frame; and
generate the one or more first material maps based at least in part generating the multidimensional frame, and wherein the output frame is generated based at least in part on the multidimensional frame.

9. The one or more processors of claim 1, wherein the one or more processors is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using AI;
a system for performing one or more operations using one or more large language models (LLMs);
a system for performing one or more operations using one or more vision language models (VLMs);
a system incorporating one or more virtual machines (VMs);
a system implemented at least partially in a data center; or
a system implemented at least partially using cloud computing resources.

10. A system comprising one or more processing units to:
receive an input frame; and
provide a first noise vector and a representation of the input frame as input into one or more first machine learning models to generate one or more first material maps, the first noise vector corresponding to an initial starting point for a diffusion process performed by the one or more first machine learning models, the one or more first material maps defining one or more properties of a surface of one or more objects in a scene.

11. The system of claim 10, wherein the one or more first material maps include at least one of: an albedo map, a normal map, a roughness map, a metallic map, or an ambient occlusion map, a displacement map, a specular map, an emissive map, an opacity map, a cavity map, or a subsurface scattering map.

12. The system of claim 10, wherein one or more processing units are further to:
receive user input requesting at least one of a material property or a lighting condition to be incorporated into an output frame; and
based at least in part on the user input, generate at least one of the one or more first material maps or the output frame.

13. The system of claim 10, wherein the one or more processing units are further to:
receive one or more lighting maps that represent at least one of one or more shading or lighting characteristics associated with the one or more objects; and
provide a representation of the or more lighting maps as input into one or more first machine learning models to generate an output frame based at least in part on the first noise vector, the one or more material maps, and the one or more lighting maps.

14. The system of claim 10, wherein the first noise vector represents a noisy version of the input frame, and wherein the one or more processing units are further to:
receive a request to enhance the input frame, wherein an output frame is generated using the one or more first machine learning models based at least in part on the request and the input frame, and wherein the output frame includes one or more features that have been enhanced relative to the input frame.

15. The system of claim 10, wherein the input image represents a two-dimensional input frame, and wherein the one or more processing units are further to:
provide the one or more first material maps, a user-specified lighting condition, and a second noise vector as input into one or more second machine learning models; and
generate an output frame based at least in part the one or more first material maps, the user-specified lighting condition, and the second noise vector as input into the one or more second machine learning models, wherein the output frame represents the two-dimensional input frame that includes a lighting property that has been modified in the output frame relative to the input frame.

16. The system of claim 10, wherein the input frame represents a two-dimensional input frame, and wherein the one or more processing units are further to:
generate a multidimensional frame based on the one or more first material maps, the multidimensional frame representing the two-dimensional input frame that includes at least one more dimension relative to the two-dimensional input frame; and
based at least on the multidimensional frame, generate one or more second material maps.

17. The system of claim 16, wherein the one or more processing units are further to:
provide a second noise vector and the one or more second material maps as input into one or more second machine learning models to generate an output frame, and wherein the output frame is generated based at least in part on generating the multidimensional frame.

18. The system of claim 10, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using AI;
a system for performing one or more operations using one or more large language models (LLMs);
a system for performing one or more operations using one or more vision language models (VLMs);
a system incorporating one or more virtual machines (VMs);
a system implemented at least partially in a data center; or
a system implemented at least partially using cloud computing resources.

19. A method comprising:
receiving at least one of: one or more first material maps, one or more first lighting maps, or an input frame;
providing a representation of at least one of: a noise vector, the one or more first material maps, the or more first lighting maps, or the input frame as input into one or more first machine learning models; and
generating an output based at least on one of the noise vector, the one or more first material maps, the one or more first lighting maps, or the input image, the output including at least one of an output frame, one or more second material maps, or one or more second lighting maps.

20. The method of claim 19, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using AI;
a system for performing one or more operations using one or more large language models (LLMs);
a system for performing one or more operations using one or more vision language models (VLMs);
a system incorporating one or more virtual machines (VMs);
a system implemented at least partially in a data center; or
a system implemented at least partially using cloud computing resources.
